(19) United States
(12) Patent Application Publication
(10) Pub. No.: US 2023/0386340 A1
(43) Pub. Date: Nov. 30, 2023

(54) DRIVING ASSISTANCE DEVICE, DRIVING ASSISTANCE SYSTEM, DRIVING ASSISTANCE METHOD AND NON-TRANSITORY COMPUTER READABLE MEDIUM

(71) Applicant: Mitsubishi Electric Corporation, Tokyo (JP)

(72) Inventor: Masaaki TAKEYASU, Tokyo (JP)

(73) Assignee: Mitsubishi Electric Corporation, Tokyo (JP)

(21) Appl. No.: 18/232,984

(22) Filed: Aug. 11, 2023

Related U.S. Application Data
(63) Continuation of application No. PCT/JP2021/013618, filed on Mar. 30, 2021.

(51) Int. Cl. G08G 1/16; B60W 30/09; B60W 30/095; B60W 60/00

(52) U.S. Cl. CPC G08G 1/166; B60W 30/09; B60W 30/0956; B60W 60/0015; G08G 1/164; B60W 2554/404; B60W 2756/10; B60W 2556/45

(57) ABSTRACT

A driving assistance device (100) includes an object existence range calculation unit (152) and a risk map generation unit (143). The object existence range calculation unit (152) calculates peripheral object distribution indicating an object existence range where there is a possibility for each object included in a peripheral object group constituted of at least one object existing around a target moving object to exist in an estimation time range, and an existence probability of each object included in the peripheral object group at each spot in the object existence range. The risk map generation unit (143) generates a potential risk map representing a potential risk indicating a risk of each object included in the peripheral object group based on the peripheral object distribution.

### CROSS REFERENCE TO RELATED APPLICATIONS

This application is a Continuation of PCT International Application No. PCT/JP2021/013618 filed on Mar. 30, 2021, which is hereby expressly incorporated by reference into the present application.

### TECHNICAL FIELD

The present disclosure relates to a driving assistance device, a driving assistance system, a driving assistance method and a driving assistance program.

### BACKGROUND ART

These days, development of automatic driving technologies has been accelerated, and through promoting the spread of automatic driving cars, efforts to realize reduction of traffic accidents, easing of traffic congestion, improvement in logistical efficiency, and movement assistance of aged people, etc. have been promoted. As a method to utilize automatic driving cars, it has been considered an unmanned automatic driving moving service in a limited area. The unmanned automatic driving moving service may be realized by an automatic driving system by remote monitoring or remote operation, that is, a remote-type automatic driving system. It is considered the use of the concerned service in a small mobility vehicle, a bus and a taxi, etc.

In the remote-type automatic driving system, monitoring and adjustment of a travelling state of an automatic driving car and a driving instruction by remote operation, etc. are performed via a communication network by a driving assistance device disposed remotely. Therefore, when communication quality adjusted beforehand is not kept due to traffic conditions, etc. around the automatic driving car, stability of vehicle control is decreased, and safety and comfortability of the automatic driving cars may be affected.

As a concrete example, Patent Literature 1 discloses a technique to suitably set a path that meets the requirements of communication quality set in accordance with an operation mode of a mobile object by acquiring communication quality in a plurality of geographical locations, and setting a path routed through an area with a high communication quality, or when an area where communication quality is estimated to decline exists, setting a path of a mobile object so as not to pass the area.

### CITATION LIST

### Patent Literature

Patent Literature 1: JP2020-165832 A

### SUMMARY OF INVENTION

### Problem to be Solved by the Invention

However, even when the technique disclosed in Patent Literature 1 is used, a delay in driving instruction from a driving assistance device to a vehicle may occur due to a cause that the requirement of communication quality acquired beforehand is no longer fulfilled due to a factor that the number of mobile objects existing in an area decided to have high communication quality at a certain point of time increases, etc., or a cause that the process is delayed, etc. due to increase in a processing load of a driving assistance device, etc. However, according to Patent Literature 1, there is a problem that when the delay in driving instruction from the driving assistance device to the vehicle occurs, it is impossible to consider change in a traffic condition that may occur during the delay.

The present disclosure is aimed at making it possible to consider, when a delay in driving instruction from a driving assistance device to a vehicle occurs, change in a traffic condition that may occur during the delay, in a remote-type automatic driving system.

### Means to Solve the Problem

There is provided according to one aspect of the present disclosure a driving assistance device includes:
an object existence range calculation unit to calculate a peripheral object distribution indicating an object existence range where there is a possibility for each object included in a peripheral object group constituted of at least one object existing around a target moving object to exist in an estimation time range, and an existence probability of each object included in the peripheral object group at each spot in the object existence range, using information on each object included in the peripheral object group in a measurement time range constituted of a time earlier than a start time of the estimation time range, and
a risk map generation unit to generate a potential risk map representing a potential risk indicating a risk of each object included in the peripheral object group based on the peripheral object distribution.

### Effects of the Invention

In the present disclosure, a risk map generation unit generates a potential risk map in an estimation time range. Herein, the potential risk map indicates a traffic condition in an area where a target moving object is moving in the estimation time range, wherein the estimation time range may be a time range in the future, and the potential risk map may be utilized to remotely control a vehicle. Therefore, according to the present disclosure, when a delay in driving instruction from a driving assistance device to a vehicle occurs, it is possible to consider change in the traffic condition that may occur during the delay in a remote-type automatic driving system.

### BRIEF DESCRIPTION OF DRAWINGS

FIG. 1 is a diagram illustrating a configuration example of a driving assistance system 90 according to a first embodiment;

FIG. 2 is a diagram illustrating an example of a functional configuration of a driving assistance device 100 according to the first embodiment;

FIG. 3 is a diagram illustrating an example of a hardware configuration of a control device 101 according to the first embodiment;

FIG. 4 is a diagram illustrating an example of a functional configuration of an integrated control device 200 according to the first embodiment;

FIG. 5 is a diagram illustrating an example of a hardware configuration of the integrated control device 200 according to the first embodiment;

FIG. 6 is a sequence diagram illustrating an operation of a driving assistance system 90 according to the first embodiment;

FIG. 7 is a flowchart illustrating a flow of a traffic condition recognition process according to the first embodiment:

FIG. 8 is a diagram describing a traffic condition map according to the first embodiment;

FIG. 9 is a diagram describing a traffic condition map according to the first embodiment, wherein (a) is a traffic condition map corresponding to a time range from a time t₀ to a time t₁, and (b) is a traffic condition map corresponding to a time range from the time t₁ to a time t₂;

FIG. 10 is a flowchart illustrating a flow of a traffic condition estimation process according to the first embodiment;

FIG. 11 is a flowchart illustrating a flow of an object existence range calculation process according to the first embodiment;

FIG. 12 is a diagram describing an existence probability map according to the first embodiment, wherein (a) is an existence probability map corresponding to a time range from a time t₀ to a time t₁, and (b) is an existence probability map corresponding to a time range from the time t₁ to a time t₂;

FIG. 13 is a flowchart illustrating a flow of a moving range estimation process according to the first embodiment;

FIG. 14 is a diagram describing a moving range according to the first embodiment, wherein (a) is a moving range map, (b) is a moving range map, (c) is a diagram describing a moving range, and (d) is a moving range map;

FIG. 15 is a flowchart illustrating a flow of a potential risk map generation process according to the first embodiment;

FIG. 16 is a diagram illustrating a potential risk determination table according to the first embodiment;

FIG. 17 is a diagram describing a potential risk map according to the first embodiment, wherein (a) is a diagram describing a moving range and an existence range, and (b) is a potential risk map;

FIG. 18 is a diagram describing a potential risk map according to the first embodiment, wherein (a) is a diagram describing a moving range and an existence range, and (b) is a potential risk map;

FIG. 19 is a flowchart illustrating a flow of an assistance information distribution process according to the first embodiment;

FIG. 20 is a flowchart illustrating a flow of a vehicle control process according to the first embodiment;

FIG. 21 is a flowchart illustrating a flow of a map correction process according to the first embodiment;

FIG. 22 is a flowchart illustrating a flow of a travelling route generation process according to the first embodiment;

FIG. 23 is a diagram describing a travelling route generation process according to the first embodiment, wherein (a) is a diagram describing a case wherein there is no spot with a high degree of potential risk, (b) is a diagram describing a case wherein there is a spot with a high degree of potential risk, (c) is a diagram describing a candidate position, and (d) is a diagram describing a candidate position;

FIG. 24 is a flowchart illustrating an operation of an object existence range calculation unit 152 according to a variation of the first embodiment;

FIG. 25 is a flowchart illustrating an operation of a moving range estimation unit 130 according to a variation of the first embodiment;

FIG. 26 is a diagram describing a potential risk map according to a variation of the first embodiment, wherein (a) is a potential risk map corresponding to a time range from the time t₀ to the time t₁, and (b) is a potential risk map corresponding to a time range from the time t₁ to the time t₂; and

FIG. 27 is a diagram illustrating an example of a hardware configuration of the driving assistance device 100 according to a variation of the first embodiment.

### DESCRIPTION OF EMBODIMENT

In description and drawings of the embodiment, the same elements and the corresponding elements are denoted by the same reference signs. Description of elements denoted by the same reference signs will be appropriately omitted or simplified. Arrows in the drawings mainly express data flows or process flows. Further, “unit” may be replaced with “circuit”, “step”, “procedure,” “processing” or “circuitry”.

### First Embodiment

Hereinafter, description will be made on the present embodiment in detail with reference to diagrams.

***Description of Configuration***

<Description of Configuration of Entire Driving Assistance System 90>

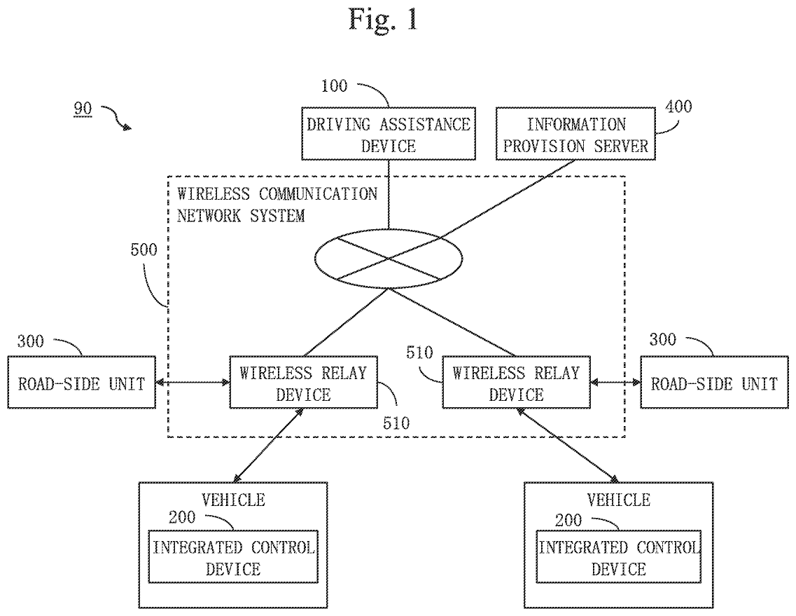

FIG. 1 illustrates a configuration example of a driving assistance system 90. As illustrated in the present diagram, the driving assistance system 90 includes a driving assistance device 100, a vehicle equipped with an integrated control device 200, a road-side unit 300, an information provision server 400 and a wireless communication network system. The driving assistance system 90 is a system related to a remote-type automatic driving system, which is a system to perform assistance related to remote control over a vehicle, and which is a system to perform monitoring and adjustment of a travelling state of a vehicle, and remote operation of a vehicle such as a driving instruction, etc. to a vehicle using a wireless communication network system. There may be any number of each element provided in the driving assistance system 90. The driving assistance system 90 is a system related to a distribution method of information on a degree of risk existing around a vehicle being an object of driving assistance in the remote-type automatic driving system, and an emergency avoidance method at the time of sudden obstacle detection on the vehicle side.

The driving assistance device 100 is a computer to provide a driving assistance service such as remote monitoring of a vehicle and remote operation of a vehicle, and so on. The driving assistance device 100 is capable of transmitting and receiving information with a vehicle via a wireless communication network. The driving assistance device 100 performs at least any of monitoring and adjustment of a travelling state of the vehicle, and remote operation of the vehicle using the information acquired from the vehicle.

A vehicle is a moving object that travels on a road, which is, for example, a four-wheeled vehicle or a two-wheeled vehicle. The vehicle is mounted with an integrated control device 200 to control behavior of the vehicle. Further, the vehicle is equipped with a wireless communication device, and is capable of transmitting and receiving information with the driving assistance device 100 by using the wireless communication device.

The integrated control device 200 is a computer mounted on the vehicle. The integrated control device 200 notifies the driving assistance device 100 of vehicle state information, vehicle position information and vehicle peripheral information, etc. acquired by a sensor group 202. The sensor group 202 is at least one sensor installed on the vehicle, which is constituted of, for example, a camera or a LiDAR (Light Detection and Ranging). Further, the integrated control device 200 controls behavior of the vehicle based on information notified from the driving assistance device 100.

A road-side unit 300 is an information collection device provided on a road. The road-side unit 300 includes a sensor such as a camera or a LiDAR, etc. Further, the road-side unit 300 includes a wireless communication unit, and is capable of transmitting and receiving information with the driving assistance device 100 by using the wireless communication unit.

An information provision server 400 is a server to provide related information being information related to automatic travelling of a vehicle. The related information is composed of, for example, information indicating a weather forecast service, and information indicating a road traffic service. As a concrete example, the driving assistance device 100 is capable of recognizing weather and congestion information, etc. in an area where a vehicle is travelling.

A wireless communication network system 500 includes a wireless communication network and one or more wireless relay devices 510. The wireless communication network may include a mobile communication network. The mobile communication network may conform to any communication system of 3G (3rd Generation), LTE (Long Term Evolution, registered trademark), 5G (5th Generation) and 6G (6th Generation), or later. Further, the wireless communication network may include a wireless LAN (Local Area Network) such as Wi-Fi (registered trademark), etc., or a wireless MAN (Metropolitan Area Network) such as WiMAX (registered trademark), etc. The wireless relay device 510 corresponds to a base station in a case wherein the wireless communication network is a mobile communication network.

<Description of Functional Configuration of Driving Assistance Device 100>

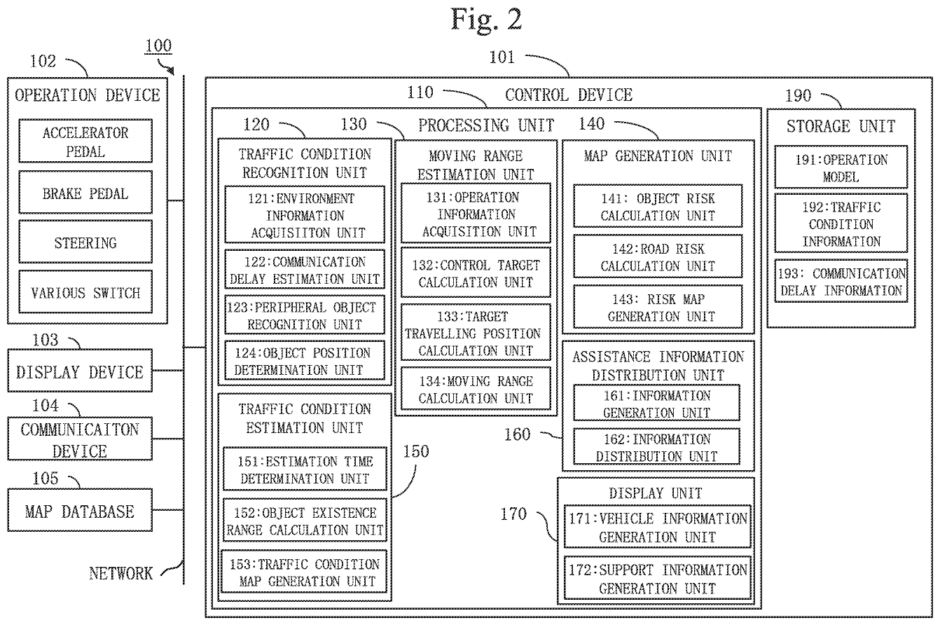

FIG. 2 illustrates a configuration example of the driving assistance device 100. Description will be made on a configuration example of the driving assistance device 100 with reference to the diagram.

The driving assistance device 100 is a device to perform driving assistance over a target vehicle by recognizing a state of an obstacle existing around the target vehicle based on information from at least any of the target vehicle and the road-side unit 300, and deciding a risk at present and in the future related to travelling of the target vehicle based on the result recognized. The target vehicle is a vehicle being an object to be performed driving assistance by the driving assistance device 100. The obstacle is, for example, a vehicle or a pedestrian. The driving assistance device 100 includes, as functional elements, a control device 101, an operation device 102, a display device 103, a communication device 104 and a map database 105, etc. The control device 101 is also called a driving assistance control device. Each component provided in the driving assistance device 100 transmits and receives data with each other via a communication interface.

The driving assistance device 100 may assists control over a moving object other than vehicles; however, for convenience of explanation, the driving assistance device 100 is assumed to assist control over a vehicle. The mobile object other than vehicles is, for example, an airplane or a vessel. The target vehicle is a concrete example of a target moving object.

The operation device 102 is a device used when a remote operator remotely operates the target vehicle by using the driving assistance device 100, which is constituted of, for example, an accelerator pedal, a brake pedal, steering, and various switches. The various switches include, for example, a direction indicator and a light switch.

The display device 103 is a device to display information received from at least any of the target vehicle, the road-side unit 300 and the information provision server 400, etc. toward a remote operator. The remote operator is one that remotely operates the target vehicle. The display device 103 may output a voice, and may include a plurality of displays.

The communication device 104 is a device to communicate with each of the target vehicle, the road-side unit 300 and the information provision server 400 via the wireless communication network system 500. The communication device 104 includes an apparatus for communication supporting a wireless communication network such as a mobile communication network, etc.

The map database 105 is a medium to store map information. The map information is high-precision map information, which includes, for example, information indicating each of each position of a traffic lane, a road shoulder and a sidewalk of a road, an attribute of the traffic lane, and a sign installed on a road. The attribute of the traffic lane includes, for example, a right-turn exclusive lane.

The control device 101 is a device to perform driving assistance over the target vehicle by recognizing a state of an obstacle existing around the target vehicle, and deciding a risk at present and in the future related to travelling of the target vehicle. The control device 101 includes a processing unit 110 and a storage unit 190.

The processing unit 110 includes a traffic condition recognition unit 120, a moving range estimation unit 130, a map generation unit 140, a traffic condition estimation unit 150, an assistance information distribution unit 160 and a display unit 170.

The traffic condition recognition unit 120 includes an environment information acquisition unit 121, a communication delay estimation unit 122, a peripheral object recognition unit 123 and an object position determination unit 124.

The environment information acquisition unit 121 is a function unit to acquire information from at least any of the target vehicle, the road-side unit 300 and the information provision server 400, etc.

The communication delay estimation unit 122 is a function unit to calculate a communication delay state between the driving assistance device 100 and the target vehicle based on the content of information transmitted and received between the driving assistance device 100 and the target vehicle. The communication delay state includes, for example, a delay time of communication. The communication delay estimation unit 122 is also called a communication delay state estimation unit.

The peripheral object recognition unit 123 is a function unit to integrate vehicle peripheral information and surrounding environment information, and to calculate peripheral object information based on the information integrated. The peripheral object information is composed of information typically indicating each of a type and a position of each peripheral object. The vehicle peripheral information is information notified to the target vehicle from at least one vehicle existing around the target vehicle, which indicates a condition around the target vehicle. The surrounding environment information is information notified from the road-side unit 300, which indicates surrounding environment of the target vehicle. The surrounding environment information may include imaging data taken by a sensor group attached to the road-side unit 300. The sensor group may be equivalent to the sensor group 202. The peripheral object is an object existing around the target vehicle. The type of the peripheral object is any one of a vehicle, a bicycle, a pedestrian, an animal, and an obstacle such as a fallen object, etc. When the type of the peripheral object is a vehicle, the peripheral object recognition unit 123 may obtain a type of the vehicle and a lamp lighting state. The type of the vehicle is, for example, any of a passenger car, a truck and a motorcycle. The lamp lighting state is, for example, any of non-lighting, lighting of a hazard lamp, and lighting of a blinker. The position of the peripheral object is typically a relative position of the peripheral object on the basis of the position of the target vehicle or the position of the road-side unit 300.

The object position determination unit 124 is a function unit to calculate a position of each peripheral object using the position of the target vehicle as a standard positon, based on vehicle position information, the position information of the road-side unit 300 and the map information stored in the map database 105. The vehicle position information is information indicating the position of the target vehicle.

The moving range estimation unit 130 includes an operation information acquisition unit 131, a control target calculation unit 132, a target travelling position calculation unit 133 and a moving range calculation unit 134. The moving range estimation unit 130 is also called a vehicle moving range estimation unit.

The operation information acquisition unit 131 is a function unit to acquire a vehicle operation amount of the remote operator output by the operation device 102 through an in-device network being a network inside the driving assistance device 100. The vehicle operation amount indicates, for example, at least any of an accelerator pedal opening, a brake pedal opening, a steering angle, switch operation information of a blinker and a head light switch, etc.

The control target calculation unit 132 is a function unit to calculate a control target value of the target vehicle from the vehicle operation amount of the remote operator. The control target value is composed of, for example, a desired acceleration and deceleration value and a desired steering angle.

The target travelling position calculation unit 133 is a function unit to calculate a target travelling position being a position where the target vehicle should travel at a certain time, based on the vehicle state information and the control target value of the target vehicle. The target travelling position calculation unit 133 is also called a target travelling position information calculation unit.

The moving range calculation unit 134 is a function unit to calculate a moving range of the target vehicle based on information indicating the target travelling position calculated by the target travelling position calculation unit 133, and to generate a moving range map based on the moving range calculated. The moving range calculation unit 134 is also called a vehicle moving range calculation unit. The moving range is a range where there is a possibility that the target vehicle exists in an estimation time range, which is also called an existence range. The moving range map is also called a vehicle moving range map. The moving range map will be described later. The moving range corresponds to a motion distribution. The moving range calculation unit 134 calculates the motion distribution using information on the target vehicle in a measurement time range constituted of time earlier than a start time of the estimation time range. The information on the target vehicle is, for example, information indicating each of the position of the target vehicle and control over the target vehicle. The motion distribution may be a distribution indicating the moving range and an existence probability of a target moving object at each spot inside the moving range.

The map generation unit 140 includes an object risk calculation unit 141, a road risk calculation unit 142 and a risk map generation unit 143. The map generation unit 140 is also called a potential risk map generation unit.

The object risk calculation unit 141 is a function unit to calculate a potential risk on a travelling route of the target vehicle based on the traffic condition map generated by the traffic condition estimation unit 150, the moving range map generated by the moving range estimation unit 130, and road information included in the map database 105. The object risk calculation unit 141 may calculate a degree of seriousness in a case wherein the target moving object and each object included in a peripheral object set collide, and an assumed collision time when the target moving object and each object included in the peripheral object set are assumed to collide, based on the motion distribution and the peripheral object distribution, and calculate a potential risk based on the degree of seriousness and the assumed collision time calculated.

The road risk calculation unit 142 is a function unit to acquire road information around the travelling route of the target vehicle from the map database 105, to extract an area where the target vehicle cannot travel from the road information acquired, and to calculate a potential risk of the area extracted.

The risk map generation unit 143 is a function unit to generate a potential risk map based on the potential risk calculated by each of the object risk calculation unit 141 and the road risk calculation unit 142. The potential risk map is a map representing a risk latent around the target vehicle, and is a map representing a potential risk inside a two-dimensional region wherein the target vehicle is looked down from the upper side. The potential risk map will be described in detail later. The potential risk indicates a risk of each object included in the peripheral object set. The potential risk may indicate a risk that the target vehicle and each object included in the peripheral object set collide. The risk map generation unit 143 generates a potential risk map based on the motion distribution and the peripheral object distribution.

The traffic condition estimation unit 150 includes an estimation time determination unit 151, an object existence range calculation unit 152 and a traffic condition map generation unit 153.

The estimation time determination unit 151 is a function unit to determine a time range and a time interval to generate a traffic condition map. The traffic condition map will be described later.

The object existence range calculation unit 152 is a function unit to calculate an existence range in a certain time range of each peripheral object recognized by the traffic condition recognition unit 120. The existence range is also called an object existence range. The object existence range calculation unit 152 calculates a peripheral object distribution using information on each object included in the peripheral object set in the measurement time range. The peripheral object distribution is a distribution indicating an object existence range and an existence probability of each object included in the peripheral object set at each spot inside the object existence range. The object existence range is a range where there is a possibility that each object included in the peripheral object set constituted of at least one object existing around the target vehicle in the estimation time range exists. Information on each object is information indicating the type and position, etc. of each object, for example.

The traffic condition map generation unit 153 is a function unit to generate a traffic condition map based on the existence range calculated by the object existence range calculation unit 152.

The assistance information distribution unit 160 includes an information generation unit 161 and an information distribution unit 162, which is also called a driving assistance information distribution unit.

The information generation unit 161 is a function unit to convert the format of the potential risk map generated by the map generation unit 140 into a format to be transmitted to the target vehicle.

The information distribution unit 162 is a function unit to distribute information indicating each piece of the control information, etc. generated by the information generation unit 161, to the target vehicle. The control information includes information indicating the potential risk map converted by the information generation unit 161 into the format to be transmitted to the vehicle. The information distribution unit 162 may notify the target vehicle of a potential risk quantized.

The display unit 170 includes a vehicle information generation unit 171 and a support information generation unit 172.

The vehicle information generation unit 171 is a function unit to generate a video indicating vehicle information, and to control the display device 103 so as to display the video generated. The vehicle information is composed of vehicle peripheral information notified from the target vehicle, and information acquired from the information provision server 400.

The support information generation unit 172 is a function unit to generate a video indicating operation support information, and to control the display device 103 so as to display the video generated. The support information generation unit 172 is also called an operation support information generation unit. The operation support information is composed of information to support operation of the target vehicle by the remote operator, which is information indicating the potential risk map generated by the map generation unit 140, for example, and information indicating a communication delay state estimated by the communication delay estimation unit 122.

The storage unit 190 stores an operation model 191, traffic condition information 192 and communication delay information 193.

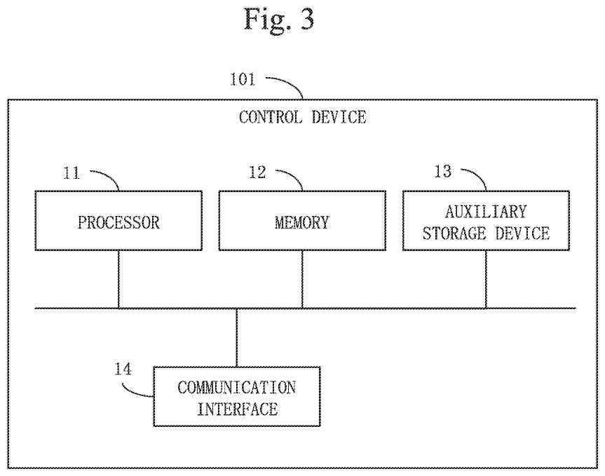

FIG. 3 illustrates an example of a hardware configuration of the control device 101. Description will be made on the example of the hardware configuration of the control device 101 with reference to the present diagram.

The control device 101 is a computer including hardware components such as a processor 11, a memory 12, an auxiliary storage device 13 and a communication interface 14, etc. These hardware components are connected with one another via a signal line. The control device 101 may be composed of a plurality of computers.

The processor 11 is an IC (Integrated Circuit) to perform arithmetic processing and to control the other hardware components included in the control device 101. The processor is, for example, a CPU (Central Processing Unit) or a GPU (Graphics Processing Unit). The control device 101 may include a plurality of processors to replace the processor 11. The plurality of processors share the roles of the processor 11.

The memory 12 is a volatile storage device. The memory 12 is also called a main storage device or a main memory. The main memory is, for example, a RAM (Random Access Memory).

The auxiliary storage device 13 is a non-volatile storage memory. The auxiliary storage device 13 is, for example, a ROM (Read Only Memory), an HDD (Hard Disk Drive) or flash memory.

The communication interface 14 is an interface to perform communication via a network, which is connected to the network. The communication interface 14 is, for example, a communication chip or an NIC (network Interface Card).

The auxiliary storage device 13 stores a driving assistance program to realize the functions of the driving assistance device 100. A driving assistance program is loaded into the memory 12 from the auxiliary storage device 13. Then, the processor 11 executes the driving assistance program.

Data used in executing the driving assistance program and data acquired by execution of the driving assistance program, etc. are stored appropriately in a storage device. The storage device is constituted of, for example, at least one of the memory 12, the auxiliary storage device 13, a register in the processor 11, and a cache memory in the processor 11. The functions of the memory 12 and the auxiliary storage device 13 may be realized by another storage device. The storage device may be independent from a computer.

Any program described in the present specification may be recorded on a computer-readable non-volatile recording medium. A specific example of the non-volatile recording medium is an optical disk or flash memory. Any program described in the present specification may be provided in the form of a program product.

<Description of Functional Configuration of Integrated Control Device 200>

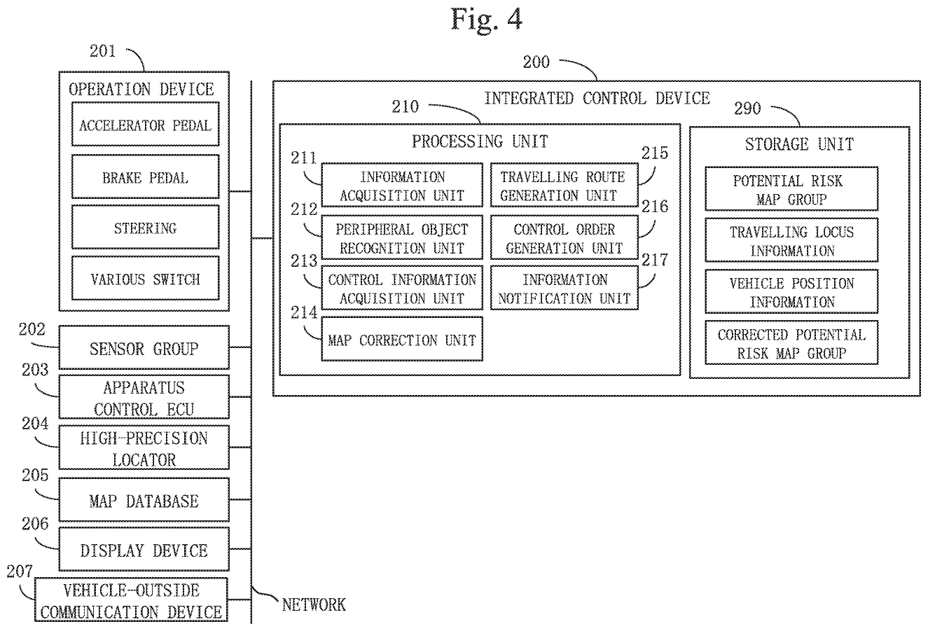

FIG. 4 illustrates a configuration example of the integrated control device 200. Description will be made on the configuration example of the integrated control device 200 with reference to the present diagram.

The integrated control device 200 is a device to control behaviors of the whole target vehicle using information inside and outside the target vehicle. The integrated control device 200 communicates with an operation device 201, a sensor group 202, an apparatus control ECU (Electronic Control Unit) 203, a high-precision locator 204, a map database 205, a display device 206 and a vehicle-outside communication device 207 via a vehicle-inside network inside the target vehicle. For the communication performed via the vehicle-inside network, a communication protocol such as a LIN (Local Interconnect Network), a CAN (Controller Area Network), an Ethernet (registered trademark) or a CXPI (Clock Extension Peripheral Interface), etc. is used.

The operation device 201 is a device to be used by a driver in operating the target vehicle, which is basically the same as the operation device 102. The driver is one to drive the target vehicle.

The sensor group 202 is constituted of one or more sensors, which is constituted of, for example, at least any one of a vehicle anterior camera a LiDAR, a radar device, a steering angle sensor and a vehicle-speed sensor.

The vehicle anterior camera is a sensor to photograph ahead of the target vehicle, which calculates a type of each object existing ahead of the target vehicle, a distance between the target vehicle and each object, and a direction of each object relative to the target vehicle, by analyzing the image taken. The type of the object is, for example, any of a vehicle, a pedestrian, an animal and an obstacle such as a fallen object, etc. When the type of the object is a vehicle, the vehicle anterior camera may calculate a direction type of the vehicle and a form of the vehicle. The direction type of the vehicle is, for example, any of a leading vehicle and an oncoming car. The form of the vehicle is, for example, any of a passenger car and a truck.

The radar device is a sensor to measure a distance between the target vehicle and each peripheral object, and a direction in which each peripheral object is located.

The steering angle sensor is a sensor to measure a direction of steering of the target vehicle.

The vehicle speed sensor is a sensor to measure the speed of the target vehicle.

The apparatus control ECU 203 is a control device to control an apparatus related to travelling of a vehicle, such as, at least any of an engine, a brake and a steering, etc.

The high-precision locator 204 calculates a present position of the target vehicle with high precision based on a positioning signal from a GNSS (Global Navigation Satellite System) satellite. In the present embodiment, the high-precision locator 204 is supposed to calculate an absolute position of the target vehicle. The absolute position is constituted of latitude and longitude.

The map database 205 is equivalent to the map database 105.

The display device 206 is typically a navigation device, which is a device to transmit information to the driver using at least any one of a video and a voice, etc. based on an instruction of the integrated control device 200.

The vehicle-outside communication device 207 is a device to communicate with each of a peripheral vehicle, the road-side unit 300 and the information provision server 400 via the wireless communication network system 500. The peripheral vehicle is a vehicle existing around the target vehicle. The vehicle-outside communication device 207 is equivalent to the communication device 104.

The integrated control device 200 is a device to control behaviors of the whole target vehicle using information inside and outside the target vehicle. In the driving assistance system 90 to realize cooperation between the driving assistance device 100 and the integrated control device 200, the integrated control device 200 controls behaviors of the target vehicle based on control information received from the driving assistance device 100. The control information is also called control instruction information. The integrated control device 200 includes a processing unit 210 and a storage unit 290 as components.

The processing unit 210 includes an information acquisition unit 211, a peripheral object recognition unit 212, a control information acquisition unit 213, a map correction unit 214, a travelling route generation unit 215, a control order generation unit 216 and an information notification unit 217.

The information acquisition unit 211 is a function unit to acquire, from the vehicle-inside network, vehicle state information indicating a state of the target vehicle, vehicle peripheral information indicating a surrounding environment of the target vehicle, and vehicle position information indicating a position of the target vehicle. The state of the target vehicle may include behaviors of the target vehicle. The vehicle state information is, for example, information indicating each of a vehicle speed, a handle steering angle, a handle steering speed and a position of the target vehicle, etc. The vehicle peripheral information is, for example, imaging data around the target vehicle acquired by the sensor group 202.

The peripheral object recognition unit 212 is a function unit to analyze the vehicle peripheral information, and to calculate a type and a position of each peripheral object, etc. based on the result analyzed. The peripheral object recognition unit 212 is equivalent to the peripheral object recognition unit 123.

The control information acquisition unit 213 is a function unit to acquire control information from the driving assistance device 100, and to store a potential risk map group included in the control information acquired in the storage unit 290. The potential risk map group is composed of at least one potential risk map. The control information includes information indicating the potential risk map group, etc.

The map correction unit 214 is a function unit to generate a corrected potential risk map by correcting each potential risk map included in the potential risk map group acquired from the driving assistance device 100 using the type and the position, etc. of each peripheral object calculated by the peripheral object recognition unit 212. The map correction unit 214 is also called a potential risk map correction unit. The map correction unit 214 may correct a potential risk map using information acquired by a sensor provided in the target moving object.

The travelling route generation unit 215 is a function unit to refer to the potential risk map notified from the driving assistance device 100, and to set a travelling route toward a target travelling position notified from the driving assistance device 100. The travelling route generation unit 215 is also called a travelling route plan unit. The travelling route generation unit 215 selects a route with a relatively low potential risk as a travelling route of the target vehicle. The travelling route generation unit 215 may use the corrected potential risk map in selecting the travelling route.

The control order generation unit 216 is a function unit to calculate a vehicle control quantity so as to travel along the travelling route set by the travelling route generation unit 215, and to transmit an operation amount of the apparatus control ECU 203 to each actuator based on the vehicle control quantity calculated.

The information notification unit 217 is a function unit to notify the driving assistance device 100 of the vehicle state information, the vehicle peripheral information and the vehicle position information acquired by the information acquisition unit 211.

The storage unit 290 stores a potential risk map group, travelling locus information, vehicle position information and a corrected potential risk map group. The corrected potential risk map group is composed of at least one corrected potential risk map.

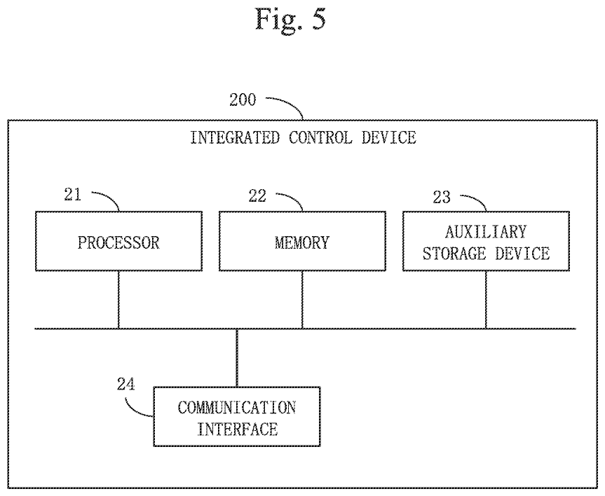

FIG. 5 illustrates an example of a hardware configuration of the integrated control device 200. Description will be made on the example of the hardware configuration of the integrated control device 200 with reference to the present diagram. The example of the hardware configuration of the integrated control device 200 is basically equivalent to the example of the hardware configuration of the driving assistance device 100.

A processor 21 is equivalent to the processor 11.

A memory 22 is equivalent to the memory 12.

An auxiliary storage device 23 is equivalent to the auxiliary storage device 13. The auxiliary storage device 23 stores an integrated control device to realize the functions of the integrated control device 200 instead of a driving assistance program.

A communication interface 24 is equivalent to the communication interface 14.

***Description of Operation***

An operation procedure of the driving assistance system 90 corresponds to a driving assistance method. Further, a program to realize the operation of the driving assistance device 100 corresponds to a driving assistance program. A program to realize the operation of the integrated control device 200 corresponds to an integrated control program.

<Process of Entire Driving Assistance System 90>

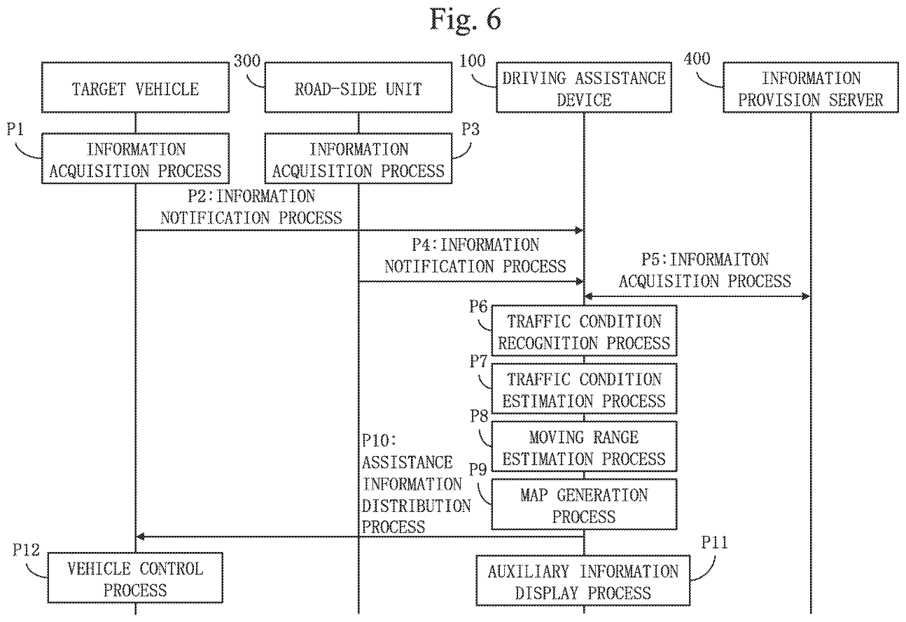

FIG. 6 illustrates a flow of a process of remote-type automatic process by the driving assistance system 90 by a sequence diagram. Description will be made on the flow of the process with reference to the present diagram. The bracket < > are used to express a subject to perform each process.

There may exist any number of target vehicles inside the driving assistance system 90; however, for convenience of explanation, description will be made on the operation of the driving assistance system 90 by assuming that one target vehicle exists inside the driving assistance system 90. When there exists a plurality of target vehicles inside the driving assistance system 90, the driving assistance device 100 appropriately performs the process as follows over each target vehicle.

Process P1. Information Acquisition Process <Target Vehicle>

The information acquisition unit 211 acquires vehicle state information, vehicle peripheral information and vehicle position information by a vehicle-inside network.

Process P2. Information Notification Process <Target Vehicle>

The information notification unit 217 notifies the driving assistance device 100 of the vehicle state information, the vehicle peripheral information and the vehicle position information acquired by the information acquisition unit 211. The traffic condition recognition unit 120 acquires the information notified from the information notification unit 217.

Process P3. Information Acquisition Process <Road-Side Unit 300>

The road-side unit 300 acquires surrounding environment information using a sensor group attached to the road-side unit 300.

Process P4. Information Notification Process <Road-Side Unit 300>

The road-side unit 300 notifies the driving assistance device 100 of the surrounding environment information and position information of the road-side unit 300. The traffic condition recognition unit 120 acquires the information notified from the road-side unit 300.

Process P5. Information Acquisition Process <Driving Assistance Device 100>

The traffic condition recognition unit 120 specifies a travelling area based on the information notified from the target vehicle and the road-side unit 300, and acquires related information in the travelling area specified by communicating with the information provision server 400. The travelling area is an area where the target vehicle travels.

Process P6. Traffic Condition Recognition Process <Driving Assistance Device 100>

The traffic condition recognition unit 120 analyzes a traffic condition around the target vehicle based on the information acquired from the target vehicle, the road-side unit 300 and the information provision server 400, and stores traffic condition information 192 indicating the traffic condition analyzed in the storage unit 190. Description on the traffic condition recognition process will be made in detail later.

Process P7. Traffic Condition Estimation Process <Driving Assistance Device 100>

The traffic condition estimation unit 150 generates a traffic condition map by estimating a traffic condition around the target vehicle at a time in the future based on the traffic condition information 192 generated by the traffic condition recognition unit 120. Description on the traffic condition estimation process will be made in detail later.

Process P8. Moving Range Estimation Process <Driving Assistance Device 100>

The control device 101 notifies the display device 103 of vehicle peripheral information notified from the target vehicle, and related information acquired from the information provision server 400. The display device 103 displays the information notified from the control device 101 on a screen of the display device 103. The remote operator operates the target vehicle remotely by using the operation device 102 while confirming the information displayed on the screen of the display device 103.

The operation information acquisition unit 131 acquires information indicating an operation amount of the remote operator.

The moving range calculation unit 134 estimates a travelling locus of the target vehicle based on information acquired by the operation information acquisition unit 131 and the vehicle peripheral information notified from the target vehicle, etc. Further, the moving range calculation unit 134 estimates an existence range of the target vehicle at a time in the future based on the travelling locus of the target vehicle estimated, and generates a moving range map based on the existence range estimated. Description on the moving range estimation process will be described in detail later. Typically, the target travelling position calculation unit 133 calculates a target travelling position of the target vehicle based on the information acquired by the operation information acquisition unit 131 and the vehicle peripheral information notified from the target vehicle, etc., and the moving range calculation unit 134 utilizes target travelling position information indicating the target travelling position calculated by the target travelling position calculation unit 133 in estimating the travelling locus.

Process P9. Map Generation Process <Driving Assistance Device 100>

The map generation unit 140 generates a potential risk map corresponding to the target vehicle using the traffic condition map generated by the traffic condition estimation unit 150 and the moving range map generated by the moving range estimation unit 130. Description on a map generation process will be made in detail later.

Process P10. Assistance Information Distribution Process <Driving Assistance Device 100>

The assistance information distribution unit 160 notifies the target vehicle of the target travelling position information calculated by the moving range estimation unit 130, and control information including information indicating the potential risk map calculated by the map generation unit 140 and position information of the target vehicle used in generating the potential risk map. The position information of the target vehicle is information typically indicating each of longitude and latitude of the position where the target vehicle exists. Description on the assistance information distribution process will be made in detail later.

Process P11. Support Information Display Process <Driving Assistance Device 100>

The support information generation unit 161 generates operation support information, and notifies the display device 103 of the operation support information generated. The display device 103 displays the operation support information notified on the screen of the display device 103. Herein, the display device 103 displays the operation support information over a movie displayed in the moving range estimation process. Further, when the display device 103 displays communication delay information 193 indicating a communication delay state as operation support information, the display device 103 may display a communication delay time as the communication delay information 193, define information indicating relation between the communication delay state and a recommended vehicle speed beforehand, and display the value of the recommended vehicle speed corresponding to the communication delay state that is occurring on the display.

Process P12. Vehicle Control Process <Target Vehicle>

The integrated control device 200 controls the target vehicle based on the control information notified by the driving assistance device 100. Description of the vehicle control process will be described in detail later.

Herein, the process of the driving assistance system 90 in a case wherein the remote operator remotely operates the target vehicle has been described; however, instead of performing remote operation of the target vehicle by the remote operator, a control device disposed on the driving assistance device 100, having an automatic driving function, may automatically operate the target vehicle by remote control. Further, the driving assistance device 100 may provide a driver of the target vehicle with driving assistance information without remotely operating the target vehicle.

<Traffic Condition Recognition Process>

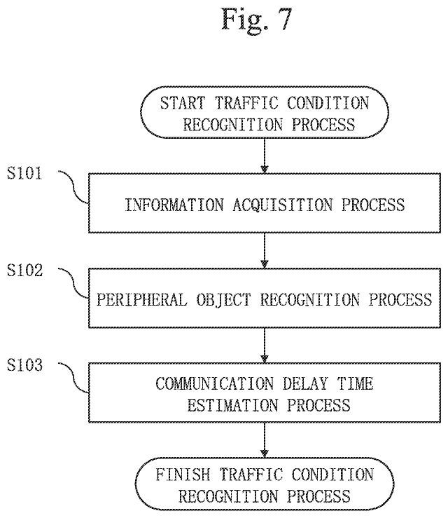

FIG. 7 is a flowchart illustrating an example of a flow of a traffic condition recognition process by the driving assistance device 100. Description will be made on the traffic condition recognition process with reference to the present diagram.

(Step S101: Information Acquisition Process)

The environment information acquisition unit 121 acquires information notified to the driving assistance device 10 by each of the integrated control device 200 and the road-side unit 300. Further, the environment information acquisition unit 121 specifies a travelling area based on the information acquired, and acquires related information in the travelling area specified by communicating with the information provision server 400.

(Step S102: Peripheral Object Recognition Process)

The peripheral object recognition unit 123 calculates peripheral object information by analyzing vehicle peripheral information notified from the target vehicle, and surrounding environment information acquired from the road-side unit 300. When each of the vehicle peripheral information and the surrounding environment information is imaging data, the peripheral object recognition unit 123 extracts a peripheral object from the imaging data. As a means to extract the peripheral object from the imaging data, an existent method such as a method using deep learning, etc. can be considered.

The object position determination unit 124 calculates object position information based on vehicle position information, position information of the road-side unit 300, and map information stored in the map database 105. The object position information is information indicating a position of each peripheral object in a case wherein the position of the target vehicle is used as a reference position.

The traffic condition recognition unit 120 stores the peripheral object information and the object position information calculated in the storage unit 190 as traffic condition information 192.

(Step S103: Communication Delay Time Estimation Process)

The communication delay estimation unit 122 calculates a communication delay time between the driving assistance device 100 and the target vehicle based on the content of the information transmitted and received between the driving assistance device 100 and the target vehicle. The communication delay estimation unit 122 stores the communication delay information 193 indicating the communication delay time calculated in the storage unit 190.

Description will be made on a concrete example of a method to calculate the communication delay time by the communication delay estimation unit 122.

First, in transmitting a message from the driving assistance device 100 to the target vehicle, the communication device 104 sets a counter value for the concerned message, and a time to transmit the concerned message by the communication device 104. In response to the concerned message from the target vehicle, the vehicle-outside communication device 207 transmits a message wherein the counter value indicated by the concerned message and a time when the vehicle-outside communication device 207 has received the message are set, to the driving assistance device 100.

Next, in transmitting a message from the target vehicle to the driving assistance device 100, the vehicle-outside communication device 207 sets a counter value for the concerned message and a time to transmit the concerned message by the vehicle-outside communication device 207. In response to the concerned message from the driving assistance device 10, the communication device 104 transmits a message wherein the counter value indicated by the concerned message and a time when the communication device 104 has received the concerned message are set, to the target vehicle.

As described above, by mutually setting a counter value, a message transmission time and a message reception time between the communication device 104 and the vehicle-outside communication device 207, the communication delay estimation unit 122 is capable of acquiring a time until the message reaches the target vehicle from the driving assistance device 100, and a time until the message reaches the driving assistance device 100 from the target vehicle, that is, the communication delay time.

<Traffic Condition Estimation Process>

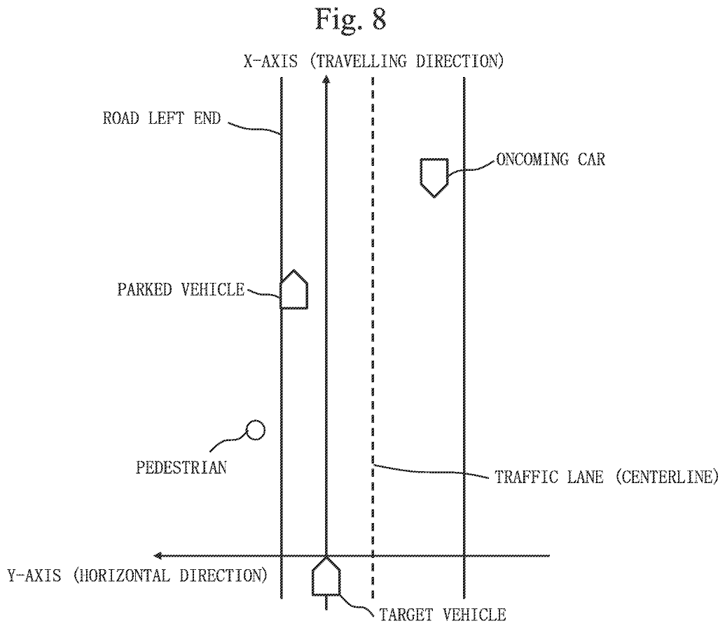

Description will be made on a traffic condition estimation process by the control device 101 using FIG. 8 through FIG. 10.

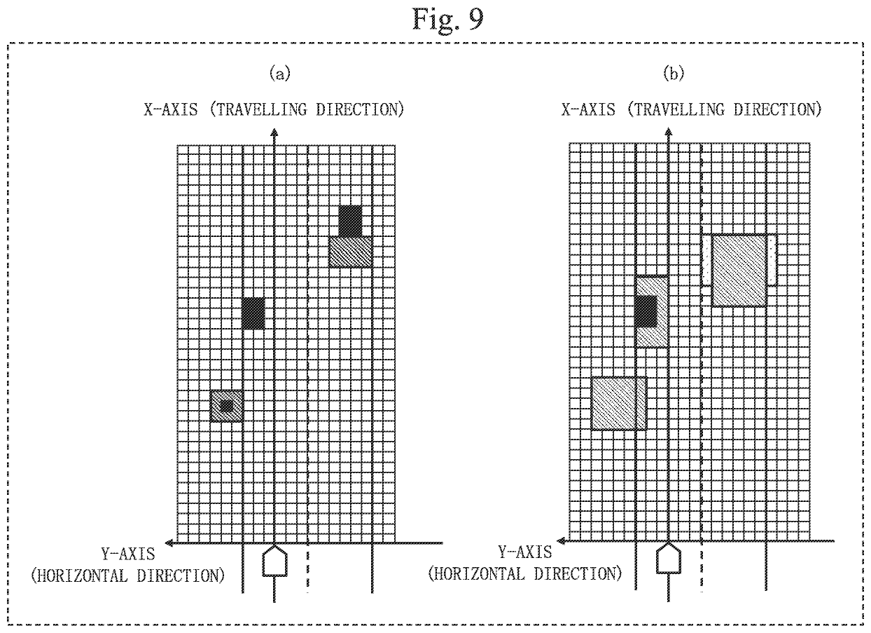

First, description will be made on a traffic condition map generated in the traffic condition estimation process using FIG. 8 and FIG. 9.

The traffic condition map is, for example, an image illustrating a state wherein a traffic condition around the target vehicle is looked down from the upper side, which represents an existence probability being a probability that each peripheral object exists at each position in a certain time range, by using a two-dimensional coordinate system with the position of the target vehicle as the origin, a travelling direction as the X axis and a horizontal direction as the Y axis. The travelling direction indicates a direction in which the target vehicle travels unless otherwise indicated. The horizontal direction is a direction to intersect the travelling direction perpendicularly.

FIG. 8 schematically illustrates a concrete example of a traffic condition at a certain time. In the present example, the target vehicle travels on a road with one lane on each side, where a parked vehicle and an oncoming car exist ahead of the target vehicle.

It is possible to calculate the position of each peripheral object in the two-dimensional coordinate system through processing by the traffic condition recognition unit 120.

The traffic condition estimation unit 150 generates a plurality of traffic condition maps at each certain time interval in a time range until a certain time tₘₐₓ (max is a natural number) being a time in the future from a time to being the present time. Herein, the time tₘₐₓ is a time in the furthest future among the time in the future corresponding to the traffic condition map generated. Concretely, the traffic condition estimation unit 150 first generates a traffic condition map corresponding to the time range from the time t₀ to the time t₁. Then, the traffic condition estimation unit 150 generates traffic condition maps corresponding to each time range from a time t₁ to a time t₂, from a time t₂ to a time t₃, . . . , from a time tₘₐₓ₋₁ to the time tₘₐₓ in order. A larger value of a suffix to t indicates a more advanced time. Further, for example, the time tₘₐₓ is a time 60 seconds after the present time, and the difference between the time tₙ₋₁ and a time tₙ (1≤n≤max, n is an integral number) is 1 second.

(a) in FIG. 9 illustrates a traffic condition map corresponding to the traffic condition illustrated in FIG. 8, and corresponding to a time range from the time t₀ to the time t₁. The traffic condition estimation unit 150 estimates an existence range of each peripheral object in the concerned time range from the time t₀ to the time t₁, and generates a traffic condition map corresponding to the concerned time range based on the result estimated. The existence range of each peripheral object may be a moving range of each peripheral object. The traffic condition map includes information indicating a peripheral object distribution.

As illustrated in (a) of FIG. 9, the traffic condition map is supposed to divide a target area in each of the direction of X-axis and the direction of Y-axis at a fixed interval. The target area is an area being an object to be generated a traffic condition map. As a concrete example, the range of the target area is a range from −10 meters to 100 meters in the direction of X-axis, and −10 meters to 10 meters in the direction of Y-axis. Further, for example, the traffic condition estimation unit 150 divides the target area into units of 0.1 meters in both of the direction of X-axis and the direction of Y-axis, and generates lattices of 0.1 meters squares. The traffic condition estimation unit 150 may calculate an existence probability of each peripheral object for each area divided, i.e., for each square. Further, the traffic condition estimation unit 150 may calculate an existence probability of each peripheral object for each set of the X-Y coordinates without dividing the target area. The existence probability of each peripheral object is a probability of existence of each peripheral object for each location or for each area inside the target area.

Further, the magnitude of the existence probability is represented by a ratio of the part which is colored black in (a) of FIG. 9. In (a) of FIG. 9, the existence probability of each peripheral object is the highest at the present position where each peripheral object exists at the time to, which becomes gradually lower as the distance from each present position increases.

(b) of FIG. 9 corresponds to the traffic condition illustrated in FIG. 8, which illustrates a traffic condition map corresponding to a time range from the time t₁ to the time t₂. By using an estimation result corresponding to the time range from the time to to the time t₁, the traffic condition estimation unit 150 estimates an existence range of each peripheral object in the time range from the time t₁ to the time t₂ being the next time range, and generates the traffic condition map based on the result estimated.

By repeating this process by changing the time range being the target in order, the traffic condition estimation unit 150 generates a plurality of traffic condition maps at certain time intervals between the time to and the time tₘₐₓ.

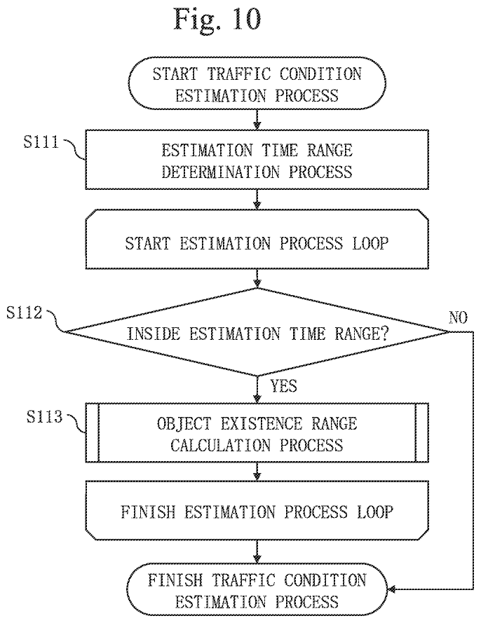

FIG. 10 is a flowchart illustrating an example of a flow of a traffic condition estimation process. Description will be made on the traffic condition estimation process with reference to FIG. 10.

(Step S111: Estimation time Range Determination Process)

The estimation time determination unit 151 determines an estimation time range being a time range to generate a traffic condition map, and a time interval to generate the traffic condition map. The estimation time range is a range from the time t₀ to the time tₘₐₓ, which is also called a generation time. The time interval is a difference between the time tₙ₋₁ and the time tₙ.

The estimation time determination unit 151 regards, for example, the time range to be 60 seconds, i.e., the time tₘₐₓ to be 60 seconds after the time t₀, and the time interval to be one second being a time interval to notify the target vehicle of control information from the driving assistance device 100. The time interval needs not be constant. As a concrete example, the estimation time determination unit 151 may regard the smallest interval of the time interval to be a time interval to notify the target vehicle of the control information from the driving assistance device 100, and lengthen the time interval as the value of n becomes larger, by taking into consideration that the prediction accuracy becomes worse as the value of n becomes larger, i.e., as time advances in the future. For example, the estimation time determination unit 151 may make the time interval longer in such a manner to repeatedly double the time interval, such as 1 second, 2 seconds, and 4 seconds.

The traffic condition estimation unit 150 executes an estimation process loop constituted of Step S112 and Step S113 for the estimation time range determined in the present process.

(Step S112)

When there is a time range in the estimation time range that is not regarded as a target time range in the estimation process loop, the traffic condition estimation unit 150 regards an earliest time range among the concerned time range as a target time range, and proceeds to Step S113. The target time range is a time range from a time tₙ₋₁ to a time tₙ. In other cases, the traffic condition estimation unit 150 finishes the process of the present flowchart.

(Step S113: Object Existence Range Calculation Process)

The object existence range calculation unit 152 calculates an existence range in a target time range of each peripheral object indicated by the traffic condition information 192 calculated by the traffic condition recognition unit 120.

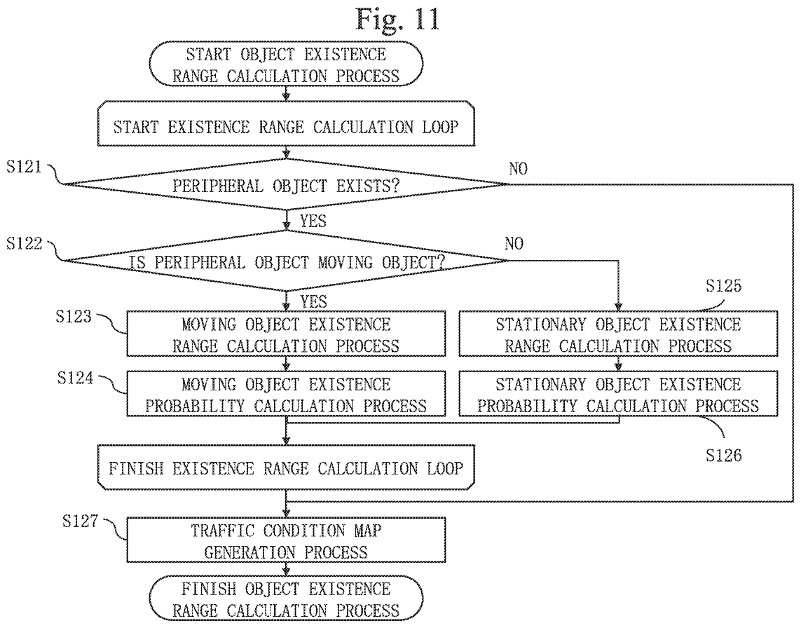

FIG. 11 is a flowchart illustrating an example of a flow of an object existence range calculation process. Description will be made on the object existence range calculation process with reference to the present diagram.

The object existence range calculation unit 152 performs an existence range calculation loop constituted of Step S121 through Step S126 for the number of peripheral objects indicated by the traffic condition information 192. In the existence range calculation loop, the object existence range calculation unit 152 obtains an existence probability map corresponding to each peripheral object. The existence probability map is a map indicating an existence range and an existence probability of each peripheral object.

(Step S121)

When there are peripheral objects that have not been selected yet in the existence range calculation loop in the peripheral objects indicated by the traffic condition information 192, the object existence range calculation unit 152 selects as a target object one peripheral object from the peripheral objects that have not been selected yet, and proceeds to Step S122. In other cases, the object existence range calculation unit 152 finishes execution of the existence range calculation loop, and proceeds to Step S127.

(Step S122)

The object existence range calculation unit 152 confirms whether a target object is a moving object. When the target object is a moving object, the object existence range calculation unit 152 proceeds to Step S123. In other cases, that is, the target object is a stationary object, the object existence range calculation unit 152 proceeds to Step S125.

(Step S123: Moving Object Existence Range Calculation Process)

The object existence range calculation unit 152 calculates an existence range in a target time range of a moving object being the target object. Herein, it is assumed that the object existence range calculation unit 152 calculates the existence range on the presupposition that, in the target time range, a speed of the moving object is unchanged as it is, typically at the speed of the moving object at the time to, and a direction in which the moving object heads is changeable.

As a concrete example, the object existence range calculation unit 152 first selects a position of the moving object at a finish time of the target time range, and calculates a travelling direction of the moving object in the target time range based on the difference between a position of the moving object at a start time of the target time range, and the position of the moving object at the finish time of the target time range selected. The travelling direction is expressed by an angle. Next, the object existence range calculation unit 152 defines a range wherein the travelling direction changes, and calculates an area wherein the moving object can move in the target time range among an area which is covered by a mobile vector indicated by [formula 1] in the range of the travelling direction defined. Herein, [formula 1] indicates each of an X-coordinate component and a Y-coordinate component of the mobile vector. A present position is a position where the moving object exists at the start time of the target time range. A future position is a position where the moving object exists at a time posterior to the start time of the target time range among the times included in the target time range.

Future position (X coordinate)=Present position (X coordinate)+cos(travelling direction)*Moving speed

Future position (Y coordinate)=Present position (Y coordinate)+sin(travelling direction)*Moving speed [Formula 1]

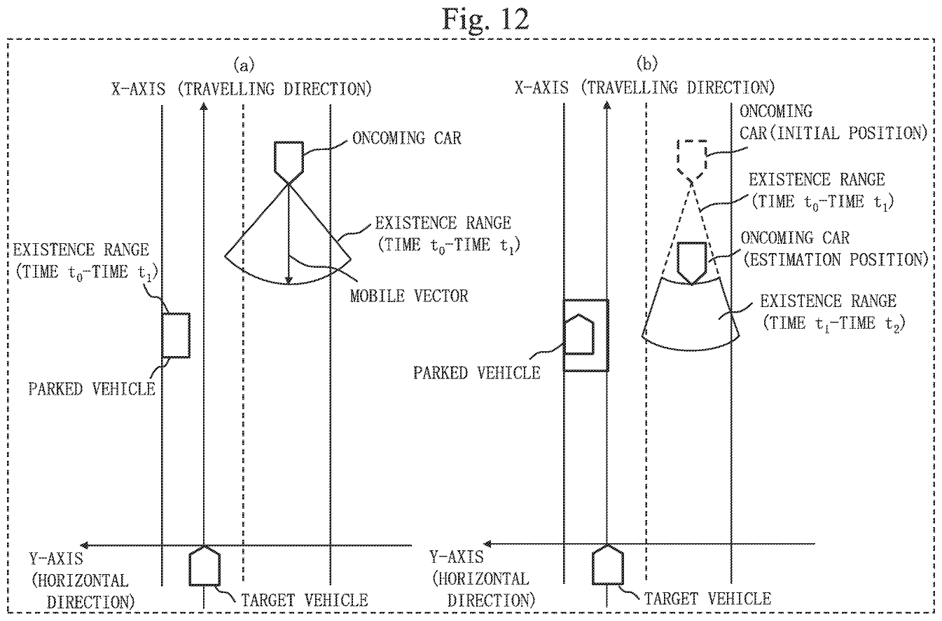

For example, when the target time range in a present cycle of the estimation process loop is from the time t₀ to the time t₁, as illustrated in (a) of FIG. 12, the object existence range calculation unit 152 selects a position of the moving object at the time t₁, and obtains a mobile vector indicating a travelling direction of the moving object based on the difference between a position of the moving object at the time to, and the position of the moving object at the time t₁ selected.

Next, the object existence range calculation unit 152 calculates a fan-shaped area having a range of a fixed angle on the both sides of the mobile vector obtained, and regards an area where the moving object can move in the target time range among the area calculated to be an existence range of the moving object. Herein, the range of the fixed angle corresponds to a range wherein the travelling direction changes. The object existence range calculation unit 152 determines a fixed angle corresponding to a movement width of the moving object in accordance with the type and the size of the mobile vector, etc. of the moving object. As a concrete example, when the moving object is a vehicle, the vehicle basically continues moving in a travelling direction for a short period of time; therefore, the object existence range calculation unit 152 defines the direction of the mobile vector to be only the travelling direction of the vehicle, and the fixed angle to be small. Further, when the moving object is a pedestrian, since the pedestrian can move in any directions, the object existence range calculation unit 152 makes the fixed angle large so that the shape of the movement width becomes a circular form or an approximately-circular fan shape, etc.

When the time range is from the time t₁ to the time t₂ and after, the object existence range calculation unit 152 calculates an existence range of the moving object based on the result obtained in a preceding cycle of the estimation process loop. When the target time range in the present cycle of the estimation process loop is from the time t₁ to the time t₂, the object existence range calculation unit 152 obtains a mobile vector as with the process as described above by assuming that the moving object exists at the future position obtained in the process corresponding to the time range from the time to to the time t₁ in the preceding cycle as illustrated in (b) of FIG. 12, and regards a fan-shaped range having the mobile vector obtained as a radius to be an existence range of the moving object. The concerned fan-shaped range corresponds to, as illustrated in (b) of FIG. 12, a range obtained by enlarging the fan form created in the preceding cycle. Herein, an initial position is typically a position observed in practice.

The object existence range calculation unit 152 may set an existence range in consideration of possibility that the target object that is not moving at present such as a parked vehicle, etc., starts travelling in the time range from the time t₁ to the time t₂ and after. In this case, the object existence range calculation unit 152 may estimate a movement prospect of the target object based on a lighting state, etc. of a lamp of the target object, and set the existence range of the target object based on the result estimated.

(Step S124: Moving Object Existence Probability Calculation Process)

The object existence range calculation unit 152 calculates an existence probability of the moving object for each position or each area in the existence range of the moving object. The object existence range calculation unit 152 obtains, as a distribution of the existence probability of the moving object, a distribution indicating that the existence probability at the present position of the moving object is 100%, and the greater the distance from the present position becomes, the smaller the existence probability becomes. As a specific example, in the distribution of the existence probability corresponding to a case wherein a vehicle being the moving object is travelling straight ahead, the existence probability is the highest on the straight line along which the moving object is travelling, and the existence probability is a relatively low fixed value in an area on the both sides of the straight line. Meanwhile, a distribution of the existence probability corresponding to a case wherein a vehicle being the moving object changes a travelling direction is an asymmetrical distribution wherein the existence probability is relatively high in a steering direction of the vehicle, and the existence probability is relatively low in an opposite direction to the steering direction. Further, distribution of the existence probability in a case wherein the moving object is a pedestrian is, as a concrete example, a distribution so as to follow a normal distribution in accordance with a distance from the present position of the pedestrian since there is a possibility that the pedestrian changes the travelling direction to any directions.

Based on the description above, the object existence range calculation unit 152 prepares a probability function beforehand for each type of the moving object and each travelling direction of the moving object, etc., and calculates an existence probability of the moving object using the probability function prepared.

The object existence range calculation unit 152 generates an existence probability map corresponding to the moving object based on the existence range obtained in Step S123, and the distribution of the existence probability.

(Step S125: Stationary Object Existence Range Calculation Process)

The object existence range calculation unit 152 regards a position of the target object and a range around the target object where the target vehicle cannot pass to be the existence range of the target object. As a concrete example, when the target object is a parked vehicle, the object existence range calculation unit 152 regards a position where the parked vehicle exists, and a range within 1.0 meter to 1.5 meters around the parked vehicle as the existence range of the parked vehicle. Herein, the position where the parked vehicle exists is an area where the parked vehicle occupies in planar view, and a value within 1.0 meters to 1.5 meters is a value known as a safe interval when a vehicle passes aside of a parked vehicle.

(Step S126: Stationary Object Existence Probability Calculation Process)

The object existence range calculation unit 152 obtains, as a distribution of an existence probability of the target object, a distribution typically indicating that the existence probability at the position of the target object is 100%, and that the greater the distance from the position becomes, the smaller the existence probability becomes. The object existence range calculation unit 152 calculates the concerned distribution in accordance with a probability function prepared beforehand, for example.

The object existence range calculation unit 152 generates an existence probability map corresponding to the existence range obtained in Step S125 and the distribution of the existence probability.

By performing the processes from Step S123 through Step 126, a peripheral object distribution is calculated.

(Step S127: Traffic Condition Map Generation Process)

The traffic condition map generation unit 153 generates a traffic condition map in a target time range by merging existence probability maps corresponding to each peripheral object obtained. In this case, when a plurality of existence probabilities are set for the same position or area, the traffic condition map generation unit 153 typically adopts only a highest existence probability.

<Moving range Estimation Process>

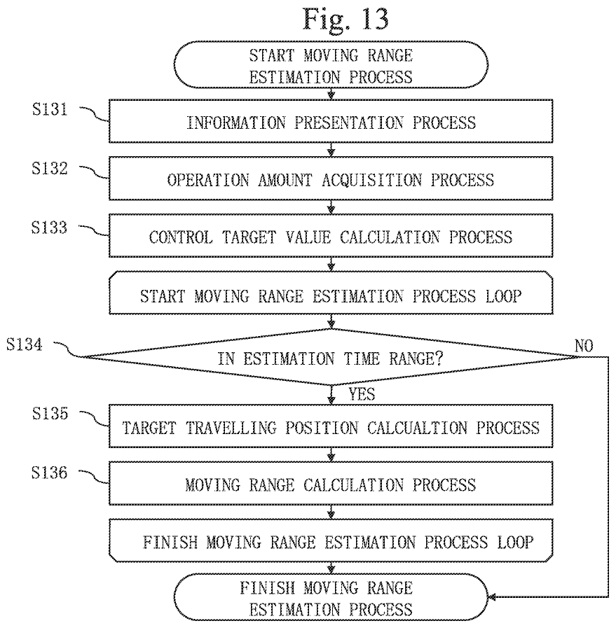

FIG. 13 is a flowchart illustrating a flow of a moving range estimation process. Description will be made on the moving range estimation process with reference to the present diagram.

(Step S131: Information Presentation Process)

The vehicle information generation unit 171 visualizes vehicle peripheral information notified from the target vehicle, and displays the vehicle peripheral information visualized on the display device 103. Further, the vehicle information generation unit 171 visualizes related information acquired from the information provision server 400, and displays the related information visualized on the display device 103.

(Step S132: Operation Amount Acquisition Process)

The remote operator operates the target vehicle using the operation device 102 while confirming the information displayed on the display device 103.

The operation information acquisition unit 131 acquires a vehicle operation amount by the remote operator output from the operation device 102, from a device-inside network. The concerned vehicle operation amount is also called a remote operation amount.

(Step S133: Control Target Value Calculation Process)

The control target calculation unit 132 generates a control target value of the target vehicle from the vehicle operation amount acquired using an operation model 191 retained in the storage unit 190. Herein, the operation model 191 is a learned model that has been created by learning relation between the remote operation amount and an actual behavior of the target vehicle in a case wherein the remote operator operates the target vehicle by remote control using the operation device 102. The behavior of the actual target vehicle includes, for example, an acceleration and deceleration speed value and a steering angle value of the target vehicle.

The control target calculation unit 132 obtains a control target value of the target vehicle by inputting information indicating each of a remote operation amount of the remote operator, a road shape, a road alignment and a road surface condition, etc. being environment conditions into the operation model 191. The road shape is, for example, any of a straight road and an intersection, etc. The road alignment is, for example, any of a straight line, a curve and a slope, etc. The road surface condition is, for example, any of drying and humid, etc. The control target calculation unit 132 acquires information indicating each of the road shape and the road alignment from the map database 105. Further, the control target calculation unit 132 may acquire information indicating the road surface by analyzing at least any of weather information acquired from the information provision server 400 and vehicle peripheral information notified from the target vehicle.

(Step S134)

The moving range estimation unit 130 performs a process of each cycle of a moving range estimation process loop constituted of Step S134 through Step S136 at fixed time intervals for the estimation time range obtained by the estimation time determination unit 151.

When there is a time range in the estimation time range, which has not been defined yet as a target time range in the moving range estimation process loop, the moving range estimation unit 130 regards an earliest time range in the concerned time range to be a target time range, and proceeds to Step S135. In other cases, the moving range estimation unit 130 finishes a process of the present flowchart.

(Step S135: Target Travelling Position Calculation Process)

When the target time range is from the time t₀ to the time t₁, the target travelling position calculation unit 133 calculates a target travelling position being a spot where the target vehicle is regarded to proceed from the time t₀ to the time t₁ based on vehicle state information and a control target value of the target vehicle. The target travelling position calculation unit 133 obtains, for example, a mobile vector based on a vehicle speed, a steering angle and a target time range, and calculates a target travelling position by adding the mobile vector obtained to the position indicated by the vehicle position information.

When the target time range is the time range from the time t₁ to the time t₂ and after, for example, the target travelling position calculation unit 133 obtains a target travelling position regarding the target vehicle to proceed as described by the mobile vector corresponding to the time range from the time t₀ to the time t₁.

The target travelling position calculation unit 133 generates travelling locus information indicating a travelling locus from the time t₀ to the time tₘₐₓ by combining target travelling positions corresponding to each time range calculated by repeatedly performing the process of the present step, and stores the travelling locus information generated in the storage unit 190.

(Step S136: Moving Range Calculation Process)

The moving range calculation unit 134 estimates a moving range of the target vehicle in the target time range based on the target travelling position obtained, the vehicle state information notified from the target vehicle and the remote operation amount. The moving range may be, for example, only a range inside a traffic lane whereon the target vehicle is travelling, or may be a range where the target vehicle is capable of taking a risk avoidance action in a case wherein a sudden risk avoidance action is taken, that is, a range including a side strip for avoidance, etc. In the description of the present flowchart, the moving range of the target vehicle may simply be indicated as a moving range.

The moving range calculation unit 134 stores the moving range for each target time range calculated in the present process as a moving range map in the storage unit 190. The moving range calculation unit 134 may obtain a probability corresponding to each spot in the moving range, which is a probability that the target vehicle actually reaches each spot, as with the moving object existence probability calculation process.

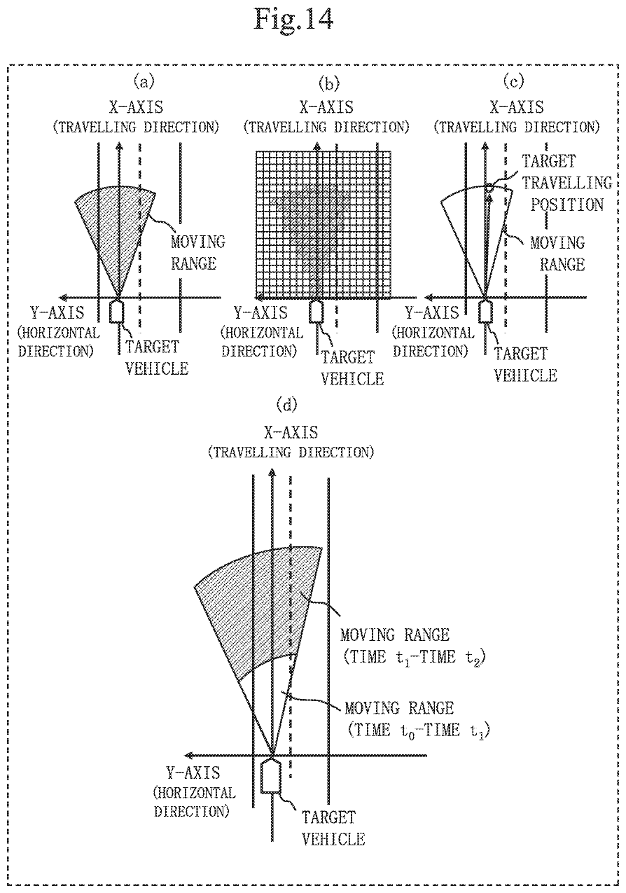

FIG. 14 is a diagram to describe a moving range.

(a) of FIG. 14 schematically illustrates a moving range map, which illustrates an estimation result of the moving range of the target vehicle based on a calculation method of the moving range described below.

(b) of FIG. 14 is to plot a moving range indicated in (a) of FIG. 14 in a map wherein the area is divided by fixed intervals for each of the X-axis direction and the Y-axis direction. The configuration of the present map is equivalent to the configuration of the traffic condition map.

When the target time range is from the time t₀ to the time t₁, the moving range calculation unit 134 obtains a moving range from the target travelling position obtained by the target travelling position calculation unit 133. As a concrete example, the moving range calculation unit 134 regards a straight line joining the present position of the target vehicle and the target moving position as a radius, and a fan-shaped range having a range of a fixed angle on the both sides of the straight line to be a moving range, as illustrated in (c) of FIG. 14.

When the target time range is the time range from the time t₁ to the time t₂ and after, the moving range calculation unit 134 assumes that the target vehicle makes uniform motion as illustrated in (d) of FIG. 14, and regards a range obtained by enlarging the moving range obtained in a preceding cycle of the moving range estimation process loop to be a moving range. The concerned range is a fan-shaped range having a radius longer than the fan-shaped radius illustrated in (a) of FIG. 14 for a distance which the target vehicle moves in the target time range.

<Potential Risk Map Generation Process>

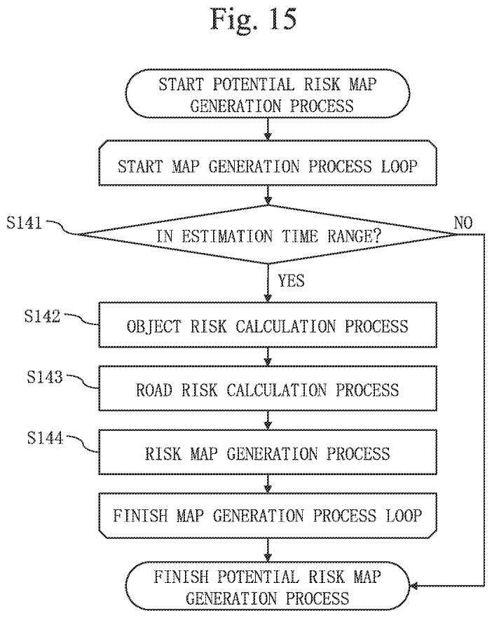

FIG. 15 is a flowchart illustrating an example of a flow of potential risk map generation process. Description will be made on the potential risk map generation process with reference to the present diagram.

The configuration of the potential risk map is equivalent to the configuration of the traffic condition map in that the configuration is expressed by a two-dimensional coordinate system with the X axis and the Y axis. Meanwhile, the potential risk map includes information indicating a potential risk value in each area different from the traffic condition map.

(Step S141)

When there is a time range in the estimation time range, which has not been regarded as a target time range yet in a map generation process loop constituted of Step S141 through Step S144, the map generation unit 140 regards an earliest time range among the concerned time range as the target time range, and proceeds to Step S142. In other cases, the map generation unit 140 finishes the process of the present flowchart.

(Step S142: Object Risk Calculation Process)

The object risk calculation unit 141 calculates a potential risk on a travelling route of the target vehicle in the target time range based on a traffic condition map generated by the traffic condition estimation unit 150, a moving range map generated by the moving range estimation unit 130, and road information indicated by the map database 105.

The object risk calculation unit 141 uses, for example, an existence probability calculated by the traffic condition estimation unit 150 as it is as a potential risk since the higher the probability of existence of a peripheral object on the travelling route of the target vehicle is, the higher the risk that the target vehicle collides with the peripheral object is.

As another method to calculate a potential risk, it is considered a method to overlap the traffic condition map and the moving range map, raise the potential risk in an area where both of the target vehicle and a peripheral object exist, and lower the potential risk in an area where only a peripheral object exists. In the case of using this method, the object risk calculation unit 141 may define a weighting constant in a case wherein both of the target object and a peripheral object exist, and obtain the potential risk by multiplying an existence probability indicated by the traffic condition map by the weighting constant. The weighting constant is a constant corresponding to double, for example. Further, the higher a possibility that both of the target vehicle and a peripheral object exist in an area is, the higher the potential risk of the area may be set by the traffic condition estimation unit 150.

Further, the object risk calculation unit 141 may define a degree of seriousness corresponding to the strength of impact at the time when the target vehicle collides with each peripheral object based on a type of each peripheral object, a travelling direction of each peripheral object and a vehicle speed of the target vehicle, and determine the potential risk using the degree of seriousness and the existence probability. In this case, by the object risk calculation unit 141, the larger the size of each peripheral object is, the higher the degree of seriousness is made to be, and the more there exist differences in the travelling direction of the object, i.e., for example, the degree of seriousness corresponding to an oncoming car is made to be higher than the degree of seriousness corresponding to a vehicle moving ahead of the target vehicle. Further, the object risk calculation unit 141 increases the degree of seriousness more as the vehicle speed of the target vehicle is larger. The degree of seriousness is defined in accordance with whether it is concerned with human life. The travelling direction of the peripheral object is, for example, any of the travelling direction of the target vehicle and a direction opposite to the travelling direction of the target vehicle.

The object risk calculation unit 141 obtains controllability of the target vehicle based on a time when the target vehicle reaches each position, and a vehicle speed of the target vehicle, etc., and determine a potential risk by combining the controllability obtained, the existence probability and the degree of seriousness. The concerned time corresponds to an assumed collision time. The controllability is an index to indicate a possibility that the target vehicle is capable of preventing collision with each peripheral object. In this case, the longer it takes for the target vehicle to reach each position, that is, the larger the value of n is regarding a traffic condition map corresponding to the time range from the time tₙ₋₁ to the time tₙ, the higher the controllability is, or the lower the vehicle speed of the target vehicle is, the higher the controllability is.

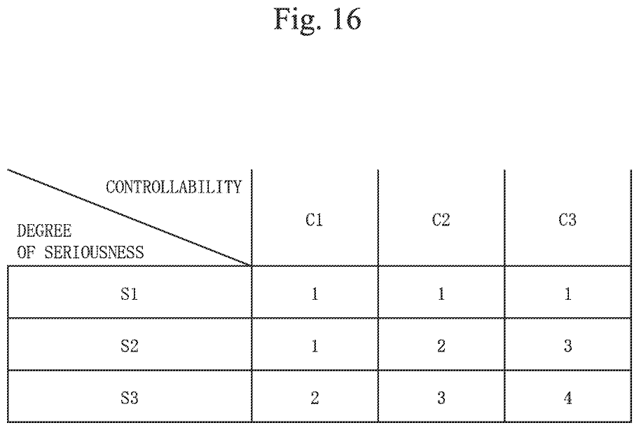

When the object risk calculation unit 141 calculates a potential risk by combining the degree of seriousness and the controllability, the object risk calculation unit 141 may calculate the potential risk using the potential risk determination table as illustrated in FIG. 16. In the concerned potential risk determination table, the degree of seriousness is classified into three stages of S1 indicating that impact is low, S2 indicating that impact is moderate, and S3 indicating that impact is high, and the controllability is classified into C1 indicating that the controllability is high, C2 indicating that the controllability is moderate, and C3 indicating that the controllability is low. Further, in the concerned potential risk determination table, the level of the potential risk, corresponding to a combination of each stage of the degree of seriousness and each stage of the controllability, is defined in four stages from 1 to 4. The object risk calculation unit 141 obtains a potential risk by multiplying an existence probability by a value indicated by the potential risk determination table as the weighting coefficient.

(Step S143: Road Risk Calculation Process)

The road risk calculation unit 142 acquires road information around a travelling route of the target vehicle, extracts an area where the target vehicle cannot travel from the road information acquired, and obtains the potential risk of the travelling route by setting the potential risk in the area extracted to the largest value. The area where the target vehicle cannot travel is, for example, a part other than roadways. The largest value is, for example, a value obtained by multiplying the largest value of the existence probability by the largest value of the weighting value.

(Step S142: Risk Map Generation Process)

The risk map generation unit 143 generates a potential risk map by merging potential risks obtained by each of the object risk calculation unit 141 and the road risk calculation unit 142.

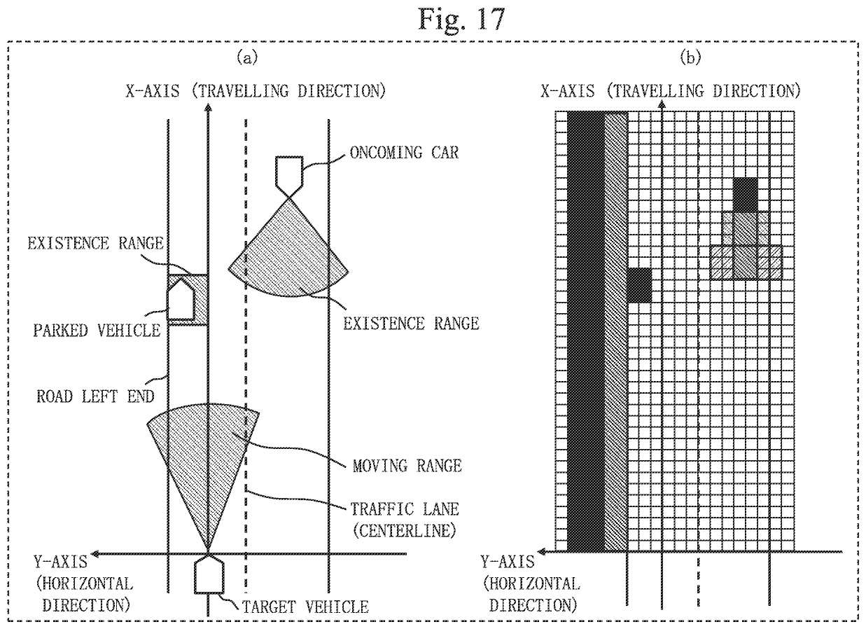

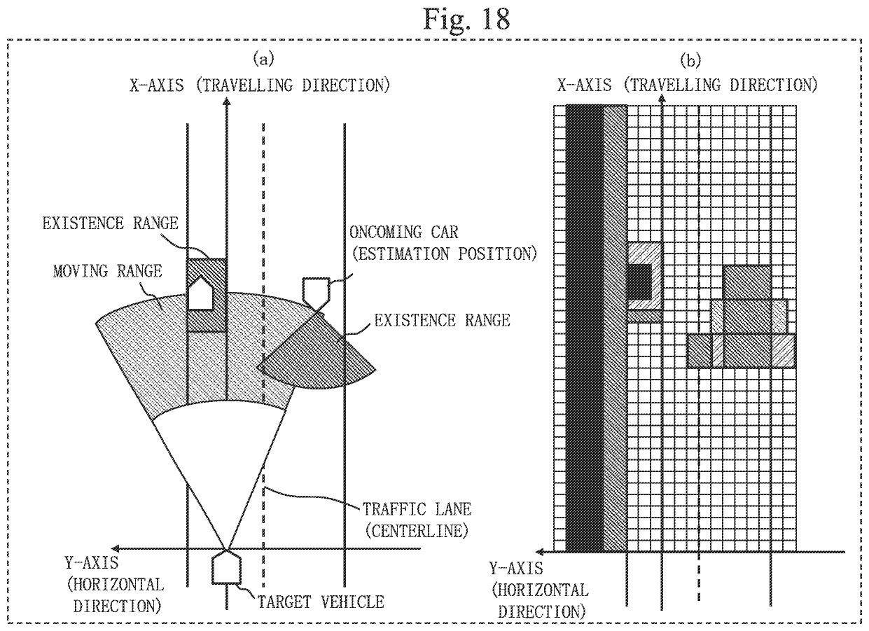

FIG. 17 and FIG. 18 are diagrams to illustrate a potential risk map. Description will be made on the potential risk map with reference to these diagrams. In FIG. 17 and FIG. 18, the magnitude of the potential risk is indicated by a ratio of the part which is colored black, wherein the higher the ratio of the part painted black is, the larger the potential risk value is.

The potential risk map is a map to generate latticed areas by regarding the position of the target vehicle as an origin, and by dividing the potential risk map at fixed intervals in each of the direction of X-axis and the direction of Y-axis, and is a map to retain potential risk information for each area generated. As a concrete example, it is considered a case wherein the potential risk map illustrates a range from −10 meters to 100 meters in the X-axis direction, and from −10 meters to 10 meters in the Y-axis direction, and indicates an area divided into a unit of 0.1 meters in both of the X-axis direction and the Y-axis direction. In this case, the potential risk map is two-dimensional array information having a width in the Y-axis direction of 200 (=20/0.1), and a height in the X-axis direction of 1100 (=110/0.1), and is information wherein a potential risk is set for each element of the two-dimensional array.

(a) of FIG. 17 illustrates a concrete example of a traffic condition at a certain time, a moving range and an existence range in the time range from the time t₀ to the time t₁.

(b) of FIG. 17 illustrates a concrete example of a potential risk map generated based on the information illustrated in (a) of FIG. 17. In (b) of FIG. 17, since there is no overlap between the existence range of the target vehicle and the existence range in each peripheral object in the state illustrated in (a) of FIG. 17, an area with a higher existence probability of each peripheral object is set to be an area with a higher potential risk.

(a) of FIG. 18 illustrates a concrete example of a moving range and an existence range in the time range from the time t₁ to the time t₂. In the condition illustrated in (a) of FIG. 18, by increasing each of the moving range and the existence range corresponding to the time range from the time t₀ to the time t₁, each of the moving range and the existence range in the time range from the time t₁ to the time t₂ is indicated. In the present condition, an existence range of a parked vehicle is expanded in consideration of a possibility that the parked vehicle starts to move.

(b) of FIG. 18 illustrates a concrete example of a potential risk map generated based on the information illustrated in (a) of FIG. 18. In the condition illustrated in (a) of FIG. 18, since there is an overlap between the existence range of the target vehicle and the existence range of the peripheral object, an area with a higher existence probability of the peripheral object is set as an area with a higher potential risk, and also a potential risk is set high in an area where the existence range of the target vehicle and the existence range of the peripheral object overlap each other.

<Assistance Information Distribution Process>

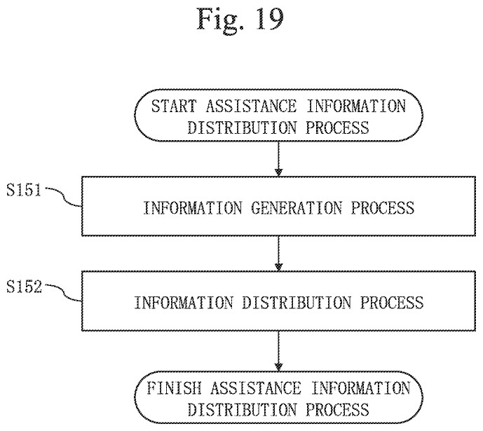

FIG. 19 is a flowchart illustrating an example of a flow of an assistance information distribution process by the driving assistance device 100. Description will be made on the assistance information distribution process with reference to the present diagram.

(Step S151: Information Generation Process)

The information generation unit 161 converts the potential risk map generated by the map generation unit 140 into a form to be notified to the target vehicle.

The potential risk map is information indicating a two-dimensional array as described above. In a case wherein the assistance information distribution unit 160 notifies the target vehicle of the potential risk map, it is preferable to notify the target vehicle of information composed of resolution information and potential risk information of the potential risk map, and information indicating a position of the target vehicle in the potential risk map. The resolution information is composed of information indicating each of width and height. The potential risk information is information indicating a potential risk for each area divided. The information indicating the position of the target vehicle is information composed of an index value indicating each area occupied by the target vehicle, which has been divided.

When the potential risk is notified, the information generation unit 161 performs quantization in order to reduce the information amount to be notified. As a method of quantization, there is a method to divide the potential risk at regular intervals between 0 and the largest value of the potential risk.

(Step S152: Information Distribution Process)

The information distribution unit 162 notifies the target vehicle of control information including travelling locus information calculated by the moving range estimation unit 130, a potential risk map converted by the information generation unit 161, position information of the target vehicle being the origin of the potential risk map, and time information corresponding to the potential risk map. The concerned position information is composed of information indicating each of latitude and longitude. The concerned time information is composed of information indicating each of an estimation time range and a time interval value. The time interval value is an earliest time among the times included in the time range corresponding to each potential risk map; that is, as a concrete example, the time interval value is the time to when the time range is from the time t₀ to the time t₁, and the time interval value is the time t₁ when the time range is from the time t₁ to the time t₂.

When the control information is notified to the target vehicle, the information distribution unit 162 typically notifies the target vehicle of all potential risk maps for each information distribution cycle for the target vehicle.

<Vehicle Control Process>

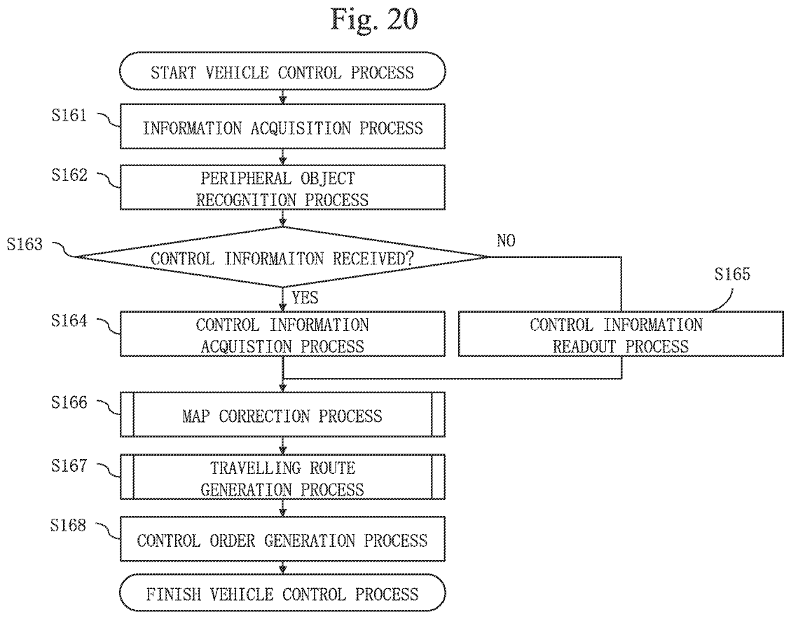

FIG. 20 is a flowchart illustrating an example of a flow of a vehicle control process by the integrated control device 200 of the target vehicle. Description will be made on the vehicle control process with reference to the present diagram.

The integrated control device 200 of the target vehicle performs the process indicated in the present flowchart for each fixed control cycle. The fixed control cycle is, for example, a cycle of 100 milliseconds.

(Step S161: Information Acquisition Process)

The information acquisition unit 211 acquires vehicle state information, vehicle peripheral information and vehicle position information of the target vehicle from the vehicle-inside network.

(Step S162: Peripheral Object Recognition Process)

The peripheral object recognition unit 212 calculates a type of each peripheral object and a position of each peripheral object by analyzing the vehicle peripheral information acquired, and when the peripheral object is a vehicle, further calculates the type of the vehicle. When the vehicle peripheral information is imaging data, the peripheral object recognition unit 212 uses a known method such as a method using deep learning, etc. as a method to extract an object from the imaging data.

(Step S163)

The control information acquisition unit 213 confirms whether the integrated control device 200 has received control information from the driving assistance device 100 in a present control cycle. When the integrated control device 200 has already received the control information, the integrated control device 200 proceeds to Step S164. In other cases, the integrated control device 200 proceeds to Step S165.

(Step S164: Control Information Acquisition Process)

The control information acquisition unit 213 acquires the control information received from the driving assistance device 100, and stores travelling locus information, a potential risk map, and position information of the target vehicle, etc. indicated by the control information acquired, in the storage unit 290.

(Step S165: Control Information Readout Process)

When it is impossible for the integrated control device 200 to receive control information from the driving assistance device 100 in the present control cycle, the integrated control device 200 reads control information retained in the storage unit 290 and performs a process. In this case, with respect to the potential risk map and the travelling locus information, the integrated control device 200 uses information corresponding to the time range from the time t₁ to the time t₂, not information corresponding to the time range from the time t₀ to the time t₁. Since information corresponding to the time range from the time t₀ to the time t₁ received in the preceding cycle is past information in the present cycle, the integrated control device 200 does not use the information corresponding to the concerned time range.

(Step S166: Map Correction Process)

With respect to the potential risk map acquired from the driving assistance device 100, the map correction unit 214 corrects the potential risk map based on the information indicating the peripheral object acquired by the peripheral object recognition unit 212. Description of the present process will be described in detail later.

(Step S167: Travelling Route Generation Process)

The travelling route generation unit 215 refers to the potential risk map, and selects a travelling route toward a target travelling position notified from the driving assistance device 100. Description of the present process will be described below in detail later.

(Step S168: Control Order Generation Process)

The control order generation unit 216 calculates a vehicle control amount in order to travel on the travelling route generated by the travelling route generation unit 215, and transmits the vehicle control amount calculated to the apparatus control ECU 203. The vehicle control amount is constituted of, for example, a desired acceleration and deceleration amount and a desired steering angle amount, etc. The apparatus control ECU 203 controls the target vehicle by generating an operation amount of each actuator based on the vehicle control amount received.

<Map Correction Process>

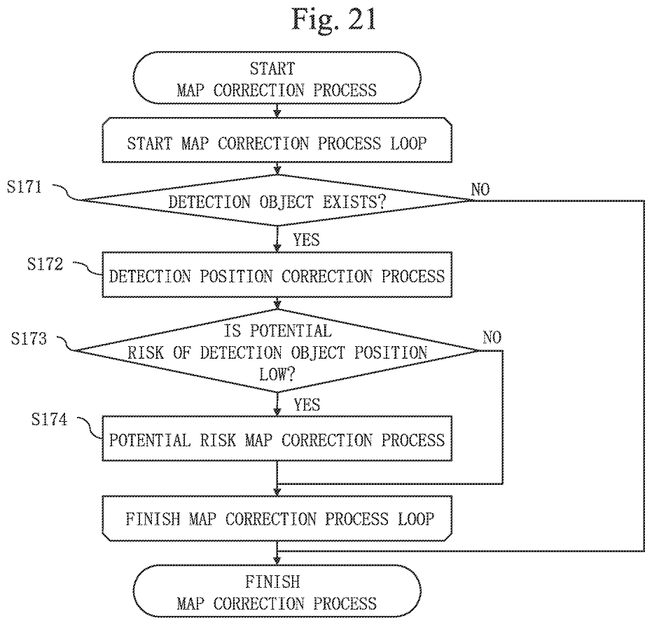

FIG. 21 is a flowchart illustrating an example of a flow of a map correction process. Description will be made on the map correction process with reference to the present diagram.

The map correction unit 214 repeatedly performs a map correction process loop constituted of Step S171 through Step S174 for the number of times of the peripheral objects acquired by the peripheral object recognition unit 212.

(Step S171)

When there are peripheral objects that have not been selected yet in the map correction process loop, the map correction unit 214 selects, as a target object, one peripheral object from among the peripheral objects that have not been selected yet, and proceeds to Step S172. In other cases, the map correction unit 214 finishes the process of the present flowchart.

(Step S172: Detection Position Correction Process)

The map correction unit 214 converts a position coordinate of the target object into a position coordinate using the position of the target vehicle determined by the driving assistance device 100 as a reference.

Specifically, the map correction unit 214 obtains a distance difference between the position of the target vehicle determined by the driving assistance device 100 and the position of the target vehicle at present in the travelling direction and the horizontal direction, and by adding the distance difference obtained with respect to the position of the target object, converts a position coordinate of the target object.

(Step S173)

By using the potential risk map acquired from the driving assistance device 100, the map correction unit 214 confirms a potential risk at the position of the target object.

When the potential risk at a position where the target object exists in a case wherein the target object is overlapped with the position of the target object on the potential risk map is low, the map correction unit 214 decides that an unrecognized obstacle is discovered at the concerned position, and proceeds to Step S174. In other cases, the map correction unit 214 performs the process of a next cycle.

(Step S174: Potential Risk Map Correction Process)

When an unrecognized obstacle is discovered, the map correction unit 214 sets each potential risk of a position where the unrecognized obstacle exists and surroundings of the concerned position in the potential risk map as the largest value. The map correction unit 214 stores a corrected potential risk map being the potential risk map corrected in the storage unit 290.

<Travelling Route Generation Process>

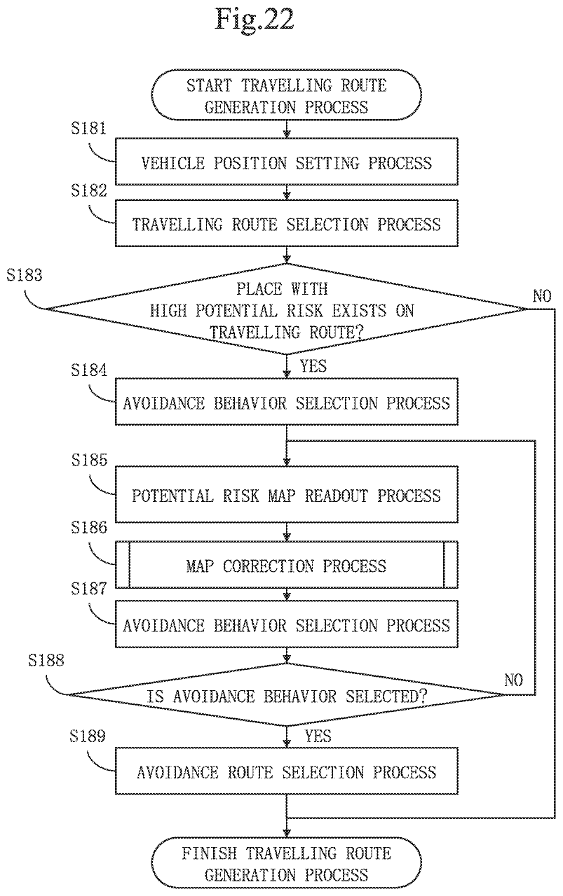

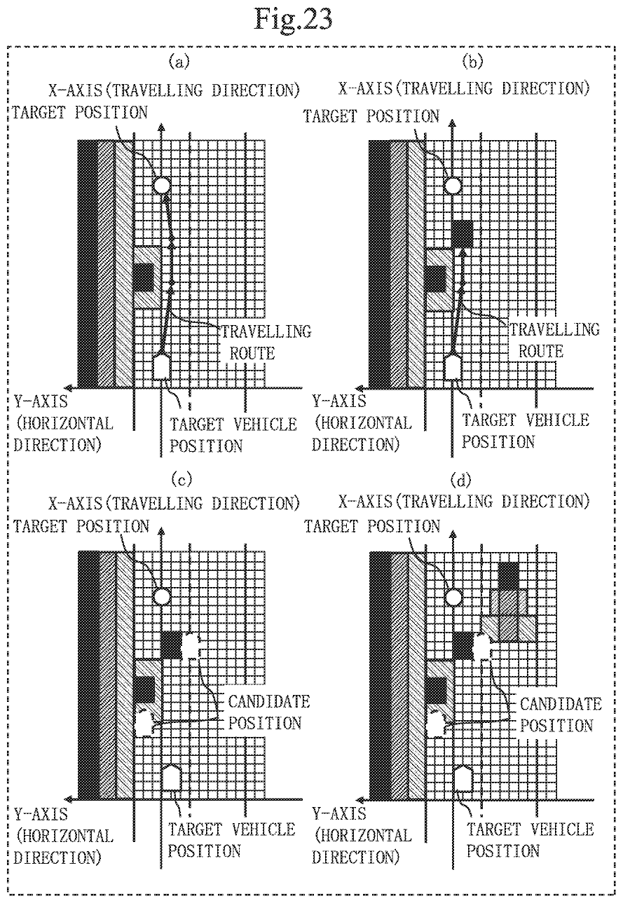

Description will be made on a travelling route generation process using FIG. 22 and FIG. 23.

FIG. 22 is a flowchart illustrating an example of a flow of the travelling route generation process. FIG. 23 schematically illustrates a situation wherein the travelling route generation unit 215 selects a travelling route. In FIG. 23, a ratio of the parts which are colored black illustrates a height of a potential risk.

(Step S181: Vehicle Position Setting Process)

The travelling route generation unit 215 performs mapping of information indicating the position of the target vehicle at present in the corrected potential risk map generated in the map correction process.

(Step S182: Travelling Route Selection Process)

The travelling route generation unit 215 selects a travelling route toward a target travelling position based on the corrected potential risk map, and the travelling locus information acquired from the driving assistance device 100. In this case, the travelling route generation unit 215 selects any route whereof a potential risk indicated in the corrected potential risk map is the smallest, as illustrated in (a) of FIG. 23. Herein, the target vehicle position in FIG. 23 indicates a position of the target vehicle at present.

The travelling route generation unit 215 may be incapable of selecting a travelling route in the present step.

(Step S183)

In a case wherein the travelling route generation unit 215 is incapable of selecting a travelling route since there is a spot with a high potential risk in a travelling route toward a target travelling position, as illustrated in (b) of FIG. 23, the travelling route generation unit 215 proceeds to Step S184. In other cases, the travelling route generation unit 215 finishes the process of the present flowchart.

(Step S184: Avoidance Behavior Selection Process)

The travelling route generation unit 215 searches for a route with a low potential risk by referring to the corrected potential risk, and selects an avoidance behavior using the result searched for. As a concrete example, in a traffic condition illustrated in (b) of FIG. 23, the travelling route generation unit 215 selects an avoidance behavior from avoidance behavior candidates such as avoiding by temporarily stopping at a side strip ahead of the target vehicle, or avoiding a spot with a high potential risk located ahead of the target vehicle and proceeding by passing the right side of the spot, etc., as illustrated in (c) of FIG. 23.

(Step S185: Potential Risk Map Readout Process)

The map correction unit 214 reads out a potential risk map corresponding to the next time range of the time range corresponding to the corrected potential risk map being referred to, from the potential risk maps stored in the storage unit 290. As a concrete example, in a case wherein the corrected potential risk map being referred to corresponds to the time range from the time t₀ to the time t₁, the map correction unit 214 reads out a potential risk map corresponding to the time range from the time t₁ to the time t₂, from the storage unit 290.

(Step S186: Map Correction Process)

The map correction unit 214 performs a map correction process, and reflects positions of peripheral objects detected at present in the potential risk map.

(Step S187: Avoidance Behavior Selection Process)

The travelling route generation unit 215 decides a potential risk in a case wherein an avoidance behavior candidate is performed, and selects any of avoidance behavior candidates with relatively low potential risks, using the corrected potential risk map.

As a concrete example, in a case of a traffic condition as illustrated in (d) of FIG. 23, a potential risk corresponding to a route passing the right side of a spot with a high potential risk ahead of the target vehicle becomes high in the next time range. Therefore, the travelling route generation unit 215 excludes the avoidance behavior candidate passing the present route. Accordingly, the travelling route generation unit 215 selects an avoidance behavior candidate to temporarily stop at a side strip ahead of the target vehicle as an avoidance behavior in the present traffic condition.

In the present step, it is not necessarily the case that the travelling route generation unit 215 is able to select an avoidance behavior.

(Step S188)

When an avoidance behavior is not selected in Step S187, the travelling route generation unit 215 returns to Step S185. In other cases, the travelling route generation unit 215 proceeds to Step S189.

By searching a future potential risk map until an avoidance behavior is determined by the travelling route generation unit 215, it is possible for the travelling route generation unit 215 to determine an avoidance behavior with a low potential risk.

(Step S189: Avoidance Route Selection Process)

The travelling route generation unit 215 determines a travelling route in performing the avoidance behavior selected in Step S187.

***Description of Effect of First Embodiment***

As described above, according to the present embodiment, a potential risk map including an estimated movement of a peripheral object at a time in the future. Therefore, in a case of the occurrence of transmission delay in control instruction from the driving assistance device 100 to the target vehicle, or a sudden dangerous event, it is possible to perform an avoidance behavior by the integrated control device 200 provided in the target vehicle even without a control instruction from the driving assistance device 100. Therefore, according to the present embodiment, it is possible to provide a remote-type automatic driving system relatively high in safety.

Further, according to the present embodiment, to make it possible to handle a case of the occurrence of delay in driving instruction between the driving assistance device 100 and a vehicle, a potential risk map, etc. is distributed as prediction information estimating a change in a traffic condition that may happen during delay. Therefore, according to the present embodiment, it is possible to reduce influence on the safety and comfort of a vehicle due to communication delay when the communication delay occurs.

***Other Configurations***

<First Variation>

Description will be made on a variation for a method to determine an estimation time range and a time interval by the estimation time determination unit 151.

The estimation time determination unit 151 may adjust the estimation time range and the time interval in accordance with a travelling route of the target vehicle.

As a concrete example, in a case wherein the target vehicle travels on a route where the risk that the target vehicle collides with a peripheral object is relatively high, the estimation time determination unit 151 shortens a time interval, and in a case wherein the target vehicle travels on a route wherein the communication environment is likely to become unstable, lengthens the estimation time range.

As a concrete example, a collision risk is determined using the information as follows.

Road Alignment

The road alignment is, for example, any of a straight line, a curve and a slope. As a concrete example, the estimation time determination unit 151 shortens the estimation time range and the time interval in a travelling route for which detailed operations are required, such as a mountain path with many curves, etc. and lengthens the estimation time range and the time interval in a straight road.

Structure

The structure is, for example, a tunnel. As a concrete example, the estimation time determination unit 151 lengthens the estimation time range in a case of approaching a travelling route where the communication environment can be unstable, such as entering a tunnel, etc.

According to the present variation, it is possible to increase and decrease the information amount to be notified to the target vehicle as needed from the driving assistance device 100, and further, to reduce the communication amount between the driving assistance device 100 and the target vehicle appropriately.

<Second Variation>

Description will be made on a variation for an object range calculation method by the object existence range calculation unit 152.

The object existence range calculation unit 152 may calculate a moving range using a learned model outputting a future position of a moving object by taking a type of a moving object, moving object information and travelling environment information as input. The type of the moving object may be, for example, any of a vehicle, a pedestrian, and an animal. The moving object information is, for example, composed of information indicating each of a position of the moving object, a vehicle speed and acceleration. The travelling environment information is, for example, composed of information indicating each of a road structure, a road surface condition, a road shape and the weather. In the present variation, the object existence range calculation unit 152 calculates a peripheral object distribution using the learned model. The learned model is a model that has learned relation between each of at least one piece of peripheral information being information of the surroundings of each moving object among at least one moving object, and each of at least one peripheral object distribution corresponding to each moving object among at least one moving object. At least one moving object corresponds to at least one piece of peripheral information on a one-to-one basis.

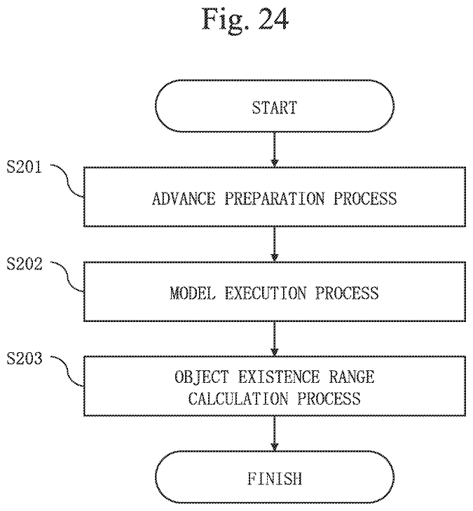

FIG. 24 is a flowchart illustrating one example of an operation of the object existence range calculation unit 152 according to the present variation. Description will be made on the operation of the object existence range calculation unit 152 with reference to the present diagram.

(Step S201: Advance Preparation Process)

The object existence range calculation unit 152 generates a moving range generation model by making a model for leaning learn a behavior history of a moving object in each travelling environment for each moving object being a peripheral object. The moving range generation model is a model to output a prediction amount when a type of the moving object, moving information of the moving object and information on a travelling environment condition, etc. are used as input. The travelling environment condition is, for example, at least any of road information of one-side lane for each direction, etc., a road shape of a straight line and a curve, etc., and weather, etc. As a concrete example, the moving range generation model is constituted of conditional probability distribution models, which is a model to obtain a motion function of the moving object and an occurrence probability of the motion function. The moving range generation model is constructed by associating each traffic condition and a probability that each behavior of a moving object occurs under each traffic condition. The motion function is a time function for each of a direction and acceleration. For example, about ten motion functions for each of the direction and acceleration are prepared. That is, in the present moving range generation model, a probability of performing a certain motion in a certain traffic condition is output. The certain motion is represented by, for example, X-axis direction acceleration and Y-axis direction acceleration. As a concrete example, when an X-axis direction acceleration function aᵢ(t) (0≤i≤9, i is an integral number) is prepared, each occurrence probability of a₀(t), a₁(t), . . . , and a₉(t) in each traffic condition is obtained from the moving range generation model. A value obtained by adding all the occurrence probabilities corresponding to each motion function is 100%. When it is assumed that acceleration of a moving object in a very short period of time is represented by a linear function, aᵢ(t) can be represented by [Formula 2]. Since a value of each aᵢ is different from the others, inclination of each aᵢ(t) is different from the others. a(0) represents acceleration at present of a moving object.

aᵢ(t)=aᵢ·t+a(0) [Formula 2]

Hereinafter, description will be made by assuming that the moving range generation model is constituted of a conditional probability distribution model. The object existence range calculation unit 152 may use a moving range generation model generated by another device.

(Step S202: Model Execution Process)

The object existence range calculation unit 152 calculates a moving speed and a travelling direction of each peripheral object as moving information of each peripheral object detected in a present cycle based on traffic condition information 192 in the present cycle and past traffic condition information 192 acquired by the traffic condition recognition unit 120. Specifically, the object existence range calculation unit 152 calculates moving information by performing motion prediction based on a difference between an existence position at present and an existence position in the past of each peripheral object. By using the moving speed and the travelling direction calculated, the object existence range calculation unit 152 calculates X-axis direction acceleration and Y-axis direction acceleration.

The object existence range calculation unit 152 acquires a motion function and an occurrence probability by inputting a type of an object, moving information of the object, a present position of the object, travelling environment information acquired from the map database 105 and the information provision server 400, etc., in the moving range generation model, for each peripheral object indicated by the traffic condition information 192.

(Step S203: Object Existence Range Calculation Process)

The object existence range calculation unit 152 calculates a position where the moving object exists at a time after a certain time using the motion function acquired. The time after a certain time is, for example, 100 milliseconds after the present time. Specifically, the object existence range calculation unit 152 calculates X-axis direction acceleration and Y-axis direction acceleration at the time after the certain time using the motion function, and calculates a position where the moving object moves from the present position based on the acceleration calculated and the certain time. By the present process, the object existence range calculation unit 152 is capable of calculating an existence position of the moving object at the time after the certain time, and an occurrence probability corresponding to the existence position.

The object existence range calculation unit 152 calculates a motion function at a next time based on the X-axis direction acceleration and the Y-axis direction acceleration of the moving object calculated, and calculates an existence position of the moving object at the next time using the motion function calculated. The next time is, for example, 200 milliseconds after the present time.

By repeatedly performing this process as described at a certain time interval, the object existence range calculation unit 152 is capable of predicting movement of the moving object in a time range from a time tₙ₋₁ to a time tₙ. The time interval is, for example, a time after 100 milliseconds, 200 milliseconds, . . . , or one second.

Further, by performing the process as described above over all combinations of motion functions output from the moving range generation model, the object existence range calculation unit 152 is capable of obtaining an existence position of the moving object in the time range from the time tₙ₋₁ to the time tdn.

By performing the process of the present step over all moving objects, the object existence range calculation unit 152 is capable of calculating an object existence range in each time range.

Further, the object existence range calculation unit 152 calculates an existence probability in an existence range of a moving object from an occurrence probability of a motion function. Specifically, the object existence range calculation unit 152 sets an existence probability at the present position of the moving object to 100%, and sets a value obtained by multiplying the existence probability set by the occurrence probability of the motion function calculated for each time range as an existence probability at the concerned present position for each time range.

Since the operation load is increased in calculating the position of the moving object for all the combinations, the object existence range calculation unit 152 may reduce the operation load by excluding a case wherein the probability of existence of a moving object is extremely low, such as to exclude a motion function whose occurrence probability is equal to or less than 30%, etc.

According to the present variation, it is possible to calculate an existence range and an existence probability of a peripheral object with relatively high accuracy.

<Third Variation>

Description will be made on a variation on a moving range calculation method by the moving range estimation unit 130.

The moving range estimation unit 130 may calculate the moving range using a learned model to output a future position using a vehicle operation amount and travelling environment information as input.

The present variation may be applied to not only a case wherein remote driving is performed based on a remote operation by a remote operator, but also a case wherein remote driving is automatically performed by a program.

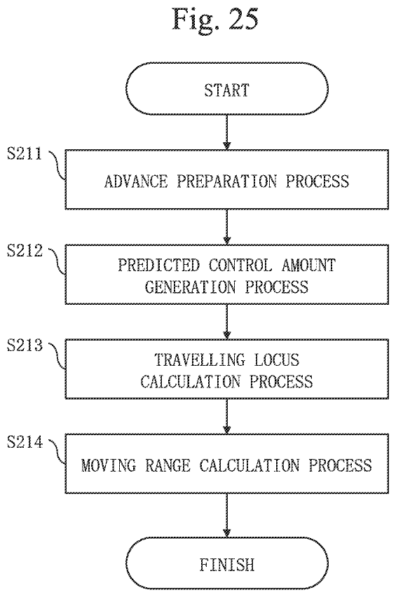

FIG. 25 is a flowchart illustrating an example of an operation of the moving range estimation unit 130 according to the present variation. Description will be made on the operation of the moving range estimation unit 130 with reference to the present diagram.

(Step S211: Advance Preparation Process)

The moving range estimation unit 130 generates a driver model by learning an operation history of a driver in the past in order to generate a predicted control amount of a target vehicle. The predicted control amount is, for example, a predicted value of a control amount for each of an accelerator opening, a brake opening and a steering angle. The driver model is a model to output a predicted control amount using information related to vehicle control, such as a vehicle speed, an accelerator opening, a brake opening, and a steering angle, etc., and information of an inter-vehicle distance with a vehicle ahead of the target vehicle, a road shape, a road alignment, and a road surface condition, etc. as input values. As a specific example, the driver model is constituted of a conditional probability distribution model, which is a model used for calculating a driving operation function of the target vehicle and an occurrence probability of the driving operation function. The driver model is a model constructed in the same manner as the moving range generation model. The driving operation function is a time function with respect to each of an accelerator opening, a brake opening and a steering angle. As a concrete example, about ten time functions are prepared with respect to each of the accelerator opening, the brake opening and the steering angle. That is, by the present driver model, a probability of a certain driving operation being performed by the driver in a certain traffic condition is output. The driving operation is, for example, to control at least any of the accelerator opening, the brake opening and the steering angle. As a concrete example, when an accelerator opening function aᵢ(t) (0≤i≤9, i is an integral number) is prepared, each occurrence probability of a₀(t), a₁(t), . . . , and a₉(t) in each traffic condition is obtained from the driver model. A value obtained by adding all occurrence probabilities corresponding to each driving operation function is 100%.

Hereinafter, the driver model is described to be constituted of a conditional probability distribution model. The moving range estimation unit 130 may use a driver model generated by another device.

(Step S212: Predicted Control Amount Generation Process)

The control target calculation unit 132 acquires a driving operation function and an occurrence probability by inputting a remote operation amount of the target vehicle by the remote operator, and travelling environment information, etc. in the driver model.

(Step S213: Travelling Locus Calculation Process)

The target travelling position calculation unit 133 calculates a predicted control amount of the target vehicle at a time after a certain time using the driving operation function acquired. The time after the certain time is 100 milliseconds after the present time. The target travelling position calculation unit 133 calculates a position where the target vehicle reaches at the time after the certain time based on the predicted control amount calculated and a motion equation of the target vehicle. The motion equation of the target vehicle is supposed to be defined beforehand based on a driving characteristic of each target vehicle. As a result, the target travelling position calculation unit 133 is capable of obtaining a position of the target vehicle at a certain time and an occurrence probability corresponding to the position.

Then, the target travelling position calculation unit 133 calculates a predicted control amount at a next time based on the predicted control amount of the target vehicle calculated and the position of the target vehicle, and calculates a position of the target vehicle at the next time using the predicted control amount calculated. The next time is, for example, 200 milliseconds after the present time. By repeatedly performing the process as described at certain time intervals, the target travelling position calculation unit 133 predicts a moving route of the target vehicle in the time range from the time tₙ₋₁ to the time tₙ. The time interval is, for example, a time after 100 milliseconds, 200 milliseconds, . . . , or one second.

By performing the process as described above over all combinations of driving operation functions output from the driver model, the target travelling position calculation unit 133 calculates a route where the target vehicle can travel in the time range from the time tₙ₋₁ to the time tₙ. Additionally, the target travelling position calculation unit 133 regards information indicating a route obtained by combining routes whose occurrence probabilities are the highest as travelling locus information.

Since the operation load is increased if the process as described above is performed on all the combinations, the target travelling position calculation unit 133 may reduce the operation load by excluding a case wherein the probability of existence of the target vehicle is extremely low, such as to exclude a driving operation function whose occurrence probability is equal to or less than 30%, etc.

(Step S214: Moving Range Calculation Process)

The moving range calculation unit 134 generates a moving range map by using an area where the target vehicle passes in the travelling locus calculated by the target travelling position calculation unit 133 as a moving range.

According to the present variation, it is possible to calculate a future travelling locus of the target vehicle and a moving range with relatively high accuracy.

<Fourth Variation>

Description will be made on a variation with respect to quantization of a potential risk map.

When a value of a potential risk exceeds a certain potential risk value, it is considered that an obstacle which the target vehicle should avoid exists irrespective of the size of the value of the potential risk. Therefore, the information generation unit makes a quantization level interval fine when the value of the potential risk is low, and makes the quantization level interval rough when the value of the potential risk is high.

Further, when the value of the potential risk is too low, it is considered that the necessity to consider the potential risk by the target vehicle is low. Therefore, the information generation unit 161 makes the quantization level interval fine in the vicinity of a mean value or a medium value, and makes the quantization interval rough in the vicinity of other values. Otherwise, the information generation unit 161 may quantize the potential risk after standardizing it. Standardization is to normalization into a distribution where the mean is 0 and the variance is 1.

As another method, the information generation unit 161 may convert the potential risk map into an image in a PGM format (Portable Graymap Format). The information generation unit 161 adds header information in the PGM format to the potential risk map. The header information in the PGM format includes information indicating each of “P2” being a magic number, a resolution and the largest value of brightness. Since the resolution corresponds to the number by which an image is divided vertically and horizontally, the information generation unit 161 sets the resolution of the potential risk map in the information indicating the resolution. The largest value of brightness is the largest value of gradation value of each pixel, for example, 255. In the present example, the potential risk is represented in 255 stages from 0 to 254.

The method to represent the potential risk in 255 stages may be a method to quantize the potential risk at regular intervals, a method to quantize the potential risk using a logarithmic scale, or the quantization method as described above.

By quantizing the potential risk as described in the present variation, it is possible to reduce information amount of the information notified to the target vehicle.

<Fifth Variation>

Description will be made on a variation with respect to a quantization method of the potential risk map by the information generation unit 161.

The information generation unit 161 may transmit information only of the vicinity where the target vehicle exists for each time range.

Further, the information generation unit 161 may obtain the largest value and the smallest value in each of a travelling direction (X-axis direction) and a horizontal direction (V-axis direction) from the moving range map obtained by the moving range estimation unit 130, and notify of only information corresponding to a rectangular range surrounded by the smallest value and the largest value obtained as potential risk map information. In this case, to make it possible to recognize a range corresponding to the potential risk map on the side of the target vehicle, the information generation unit 161 also notifies of information indicating the smallest value and the largest value obtained.

The information generation unit 161 may increase the range to be notified to the target vehicle by adding a certain fixed correction value to the smallest value and the largest value.

By regarding the size of the potential risk map as only an area where the target vehicle can exist as described in the present variation, it is possible to suppress the information amount of the information notified to the target vehicle.

<Sixth Variation>

Description will be made on a variation with respect to a distribution method of driving assistance information by the information generation unit 161.

The information generation unit 161 may generate information retaining a potential risk for each time or each time range.

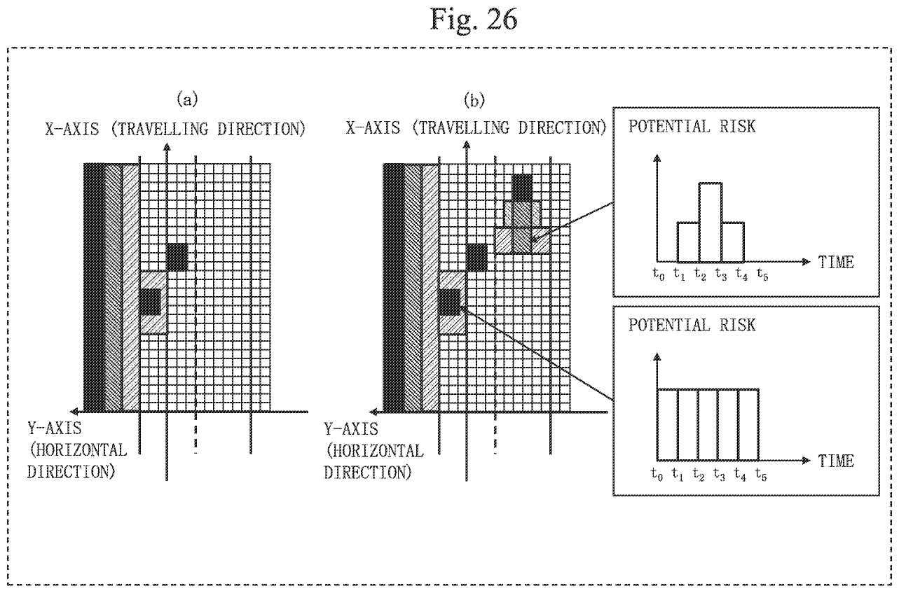

FIG. 26 is a diagram illustrating a process in the present variation.

(a) of FIG. 26 schematically illustrates a concrete example of a potential risk map corresponding to the time range from the time t₀ to the time t₁. (b) of FIG. 26 schematically illustrates a concrete example of a potential risk map corresponding to the time range from the time t₁ to the time t₂. As described, by obtaining the potential risk for each time range from the time tₙ₋₁ to the time iₙ, the information generation unit 161 is capable of generating time-series data illustrating relation between each time range and the potential risk for each position, as in the graph illustrated in (b) of FIG. 26.

As a specific example, the information generation unit 161 may encode the time-series data generated using SAX (Symbolic Aggregate Approximation), and notify the target vehicle of information for each time encoded as information of the potential risk map. In this case, the information notified on the side of target vehicle is returned again to information for each time range.

<Seventh Variation>

Description will be made on a variation with respect to a distribution method of driving assistance information by the information distribution unit 162.

The information distribution unit 162 may determine a transmission method of the potential risk map in accordance with a travelling route of the target vehicle or a communication delay state, etc. The assistance information distribution unit 162 according to the present variation determines whether to notify a target moving object of the potential risk map in accordance with communication quality between the driving assistance device 100 and the target moving object. The communication quality may be defined in accordance with amount of information included in peripheral vehicle information.

As a concrete example, the information distribution unit 162 may transmit the potential risk map for each control cycle at each cycle, and determine a timing to transmit a potential risk map corresponding to another time range in consideration of the travelling route and the communication delay state. The potential risk map for each control cycle is a potential risk map corresponding to the time range from the time t₀ to the time t₁.

As a concrete example, the information distribution unit 162 determines the timing to transmit as follows.

Travelling Route

When a travelling route is a straight road, since an object existing in a distant position in the peripheral vehicle information acquired by the target vehicle, prediction accuracy of a potential risk map corresponding to a time in the future is guaranteed to a certain degree. Therefore, when the travelling route is a straight road, the information distribution unit 162 may decrease the transmission frequency such as to notify of a future potential risk map once per 10 control cycles. The future potential risk map is a potential risk map corresponding to each time range of the time range from the time t₁ to the time t₂ and after.

Meanwhile, when the travelling route is a mountain path, etc. with many curves, since it is considered that many objects not included in the peripheral vehicle information acquired by the target vehicle, such as a vehicle existing ahead of a curve exist, the prediction accuracy of the potential risk map corresponding to the time in the future is considered to be low. Therefore, when the travelling route is a mountain path, etc. with many curves, the information distribution unit 162 may keep the transmission frequency to a certain degree, such as to notify of the future potential risk map once per two control cycles, and so on.

Communication Delay State

The information distribution unit 162 estimates a communication delay state based on transition from the past to the present with respect to the communication delay time information obtained by the communication delay estimation unit 122. As a concrete example, when the communication delay time gradually becomes longer, in order to decrease a degree of usage of a communication band, the information distribution unit 162 may decrease the transmission frequency, such as to transmit the future potential risk map once per 10 control cycles, etc.

As another method, the information distribution unit 162 may use a method to calculate a use communication band quantity based on an information amount notified to all target vehicles from the driving assistance device 100, and with respect to target vehicles corresponding to a relatively large use communication band quantity, assign a transmission cycle of a future potential risk map to each target vehicle and transmit the future potential risk map.

According to the present variation, it is possible to reduce the information amount of the information notified to the target vehicle by limiting the number of transmission of potential risk maps.

<Eighth Variation>

The driving assistance device 100 may generate a potential risk map without generating and using a moving range map.

In the present variation, for example, the map generation unit 140 generates a potential risk map by using an existence probability calculated by the traffic condition estimation unit 150 as it is as a potential risk. Further, the target vehicle judges a risk of each peripheral object to the target vehicle based on the potential risk map and vehicle peripheral information, and automatically controls the target vehicle.

<Ninth Variation>

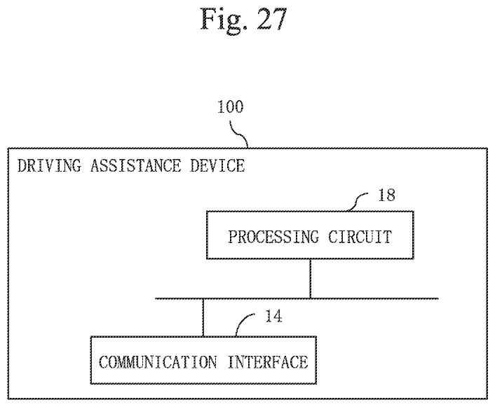

FIG. 27 illustrates an example of a hardware configuration of the driving assistance device 100 according to the present variation.

The driving assistance device 100 includes a processing circuit 18 instead of the processor 11, the processor 11 and the memory 12, the processor 11 and the auxiliary storage device 13, or the processor 11, the memory 12 and the auxiliary storage device 13.

The processing circuit 18 is a hardware component to realize at least a part of each unit included in the driving assistance device 100.

The processing circuit 18 may be a dedicated hardware component, or a processor to execute a program stored in the memory 12.

When the processing circuit 18 is the dedicated hardware component, the processing circuit 18 is, for example, a single circuit, a composite circuit, a processor made into a program, a processor made into a parallel program, an ASIC (ASIC is Application Specific Integrated Circuit), an FPGA (Field Programmable Gate Array), or a combination thereof.

The driving assistance device 100 may include a plurality of processing circuits replacing the processing circuit 18. The plurality of processing circuits share the roles of the processing circuit 18.

In the driving assistance device 100, a part of the functions may be realized by dedicated hardware, and the remaining functions may be realized by software or firmware.

The processing circuit 18 is, for example, realized by hardware, software, firmware or a combination thereof.

The processor 11, the memory 12, the auxiliary storage device 13 and the processing circuit 18 are collectively called “processing circuitry”. That is, functions of each functional component of the driving assistance device 100 are realized by processing circuitry.

Further, the integrated control device 200 may have a configuration equivalent to the present variation.

### Another Embodiment

Description has been made on the first embodiment, and a plurality of parts in the present embodiment may be combined and performed. Meanwhile, the present embodiment may be partially performed. Otherwise, various alterations of the present embodiment are possible as needed, and the present embodiment may be combined and performed partially or as a whole in any manner of combination.

The embodiment as described above is essentially preferable examples, and is not intended for limiting the scope of the present disclosure, the application and range of use thereof. It may be possible to appropriately change the procedures described using flowcharts, etc.

### REFERENCE SIGNS LIST

11, 21: processor; 12, 22: memory; 13, 23: auxiliary storage device; 14, 24: communication interface; 18: processing circuit; 90: driving assistance system; 100: driving assistance device; 101: control device; 102: operation device; 103: display device; 104: communication device; 105: map database; 110: processing unit; 120: traffic condition recognition unit; 121: environment information acquisition unit; 122: communication delay estimation unit; 123: peripheral object recognition unit; 124: object position determination unit; 130: moving range estimation unit; 131: operation information acquisition unit; 132: control target calculation unit; 133: target travelling position calculation unit; 134: moving range calculation unit; 140: map generation unit; 141: object risk calculation unit; 142: road risk calculation unit; 143: risk map generation unit; 150: traffic condition estimation unit; 151: estimation time determination unit; 152: object existence range calculation unit; 153: traffic condition map generation unit; 160: assistance information distribution unit; 161: information generation unit; 162: information distribution unit; 170: display unit; 171: vehicle information generation unit; 172: support information generation unit; 190: storage unit; 191: operation model; 192: traffic condition information; 193: communication delay information; 200: integrated control device; 201: operation device; 202: sensor group; 203: apparatus control ECU; 204: high-precision locator; 205: map database; 206: display device; 207: vehicle-outside communication device; 210: processing unit; 211: information acquisition unit; 212: peripheral object recognition unit; 213: control information acquisition unit; 214: map correction unit; 215: travelling route generation unit; 216: control order generation unit; 217: information notification unit; 290: storage unit; 300: road-side unit; 400: information provision server; 500: wireless communication network system; 510: wireless relay device.

1. A driving assistance device comprising
processing circuitry to:
calculate a peripheral object distribution indicating an object existence range where there is a possibility for each object included in a peripheral object group constituted of at least one object existing around a target moving object to exist in an estimation time range, and an existence probability of each object included in the peripheral object group at each spot in the object existence range, using information on each object included in the peripheral object group in a measurement time range constituted of a time earlier than a start time of the estimation time range, and
generate a potential risk map representing a potential risk indicating a risk of each object included in the peripheral object group based on the peripheral object distribution, wherein
the processing circuitry calculates the peripheral object distribution using a learned model which has learned a relation between each of at least one piece of peripheral information being information on a periphery of each moving object included in at least one moving object and each of at least one piece of peripheral object distribution corresponding to each moving object included in the at least one moving object, and
the at least one moving object and the at least one piece of peripheral information correspond to each other on a one-to-one basis.

2. The driving assistance device as defined in claim 1, wherein
the processing circuitry calculates a motion distribution indicating a moving range where there is a possibility that the target moving object exists in the estimation time range, using information on the target moving object in the measurement time range,
the potential risk indicates a risk that the target moving object and each object included in the peripheral object group collides with each other, and
the processing circuitry generates the potential risk map based on the motion distribution and the peripheral object distribution.

3. The driving assistance device as defined in claim 2, wherein the motion distribution indicates an existence probability of the target moving object at each spot in the moving range.

4. The driving assistance device as defined in claim 2, wherein
the processing circuitry obtains, based on the motion distribution and the peripheral object distribution, a degree of seriousness in a case wherein the target moving object and each object included in the peripheral object group collide with each other, and an assumed collision time at which the target moving object and each object included in the peripheral object group are assumed to collide with each other, and calculates the potential risk based on the degree of seriousness and the assumed collision time obtained, and
the processing circuitry generates the potential risk map using the potential risk calculated.

5. The driving assistance device as defined in claim 1, wherein the learned model is a conditional probability distribution model.

6. The driving assistance device as defined in claim 1, wherein the processing circuitry notifies the target moving object of the potential risk map.

7. The driving assistance device as defined in claim 6, wherein the processing circuitry determines whether to notify the target moving object of the potential risk map in accordance with a communication quality between the driving assistance device and the target moving object.

8. The driving assistance device as defined in claim 6, wherein the processing circuitry notifies the target moving object of a potential risk quantized.

9. An driving assistance system including the driving assistance device as defined in claim 6, and the target moving object, wherein the target moving object includes an integrated control device equipped with processing circuitry to select a route whereof the potential risk is relatively low as a travelling route of the target moving object based on the potential risk map notified from the driving assistance device.

10. The driving assistance system as defined in claim 9, wherein
the processing circuitry of the integrated control device corrects the potential risk map notified from the driving assistance device using information acquired by a sensor provided in the target moving object, and
the processing circuitry of the integrated control device selects the travelling route using the potential risk map corrected.

11. A driving assistance method comprising:
calculating a peripheral object distribution indicating an object existence range where there is a possibility for each object included in a peripheral object group constituted of at least one object existing around a target moving object to exist in an estimation time range, and an existence probability of each object included in the peripheral object group at each spot in the object existence range, using information on each object included in the peripheral object group in a measurement time range constituted of a time earlier than a start time of the estimation time range,
generating a potential risk map representing a potential risk indicating a risk of each object included in the peripheral object group based on the peripheral object distribution, and
calculating the peripheral object distribution using a learned model which has learned a relation between each of at least one piece of peripheral information being information on a periphery of each moving object included in at least one moving object and each of at least one piece of peripheral object distribution corresponding to each moving object included in the at least one moving object, wherein
the at least one moving object and the at least one piece of peripheral information correspond to each other on a one-to-one basis.

12. A non-transitory computer readable medium storing a driving assistance program to make a driving assistance device being a computer perform:
an object existence range calculation process to calculate a peripheral object distribution indicating an object existence range where there is a possibility for each object included in a peripheral object group constituted of at least one object existing around a target moving object to exist in an estimation time range, and an existence probability of each object included in the peripheral object group at each spot in the object existence range, using information on each object included in the peripheral object group in a measurement time range constituted of a time earlier than a start time of the estimation time range, and
a risk map generation process to generate a potential risk map representing a potential risk indicating a risk of each object included in the peripheral object group based on the peripheral object distribution, wherein
in the object existence range calculation process, calculating the peripheral object distribution using a learned model which has learned a relation between each of at least one piece of peripheral information being information on a periphery of each moving object included in at least one moving object and each of at least one piece of peripheral object distribution corresponding to each moving object included in the at least one moving object, and
the at least one moving object and the at least one piece of peripheral information correspond to each other on a one-to-one basis.
